(19) United States
(12) Patent Application Publication
(10) Pub. No.: US 2026/0304332 A1
(43) Pub. Date: Oct. 1, 2026

(54) TECHNIQUES FOR PHYSICAL RANDOM ACCESS CHANNEL OCCASION IN CELLS WITH ADAPTIVE SYNCHRONIZATION SIGNAL BLOCK TRANSMISSION

(71) Applicant: Qualcomm Incorporated, San Diego, CA (US)

(72) Inventor: Hung Dinh LY, San Diego, CA (US)

(21) Appl. No.: 19/427,756

(22) Filed: Dec. 19, 2025

Related U.S. Application Data
(60) Provisional application No. 63/777,312, filed on Mar. 25, 2025.

(51) Int. Cl. H04W 56/00; H04L 5/00; H04W 74/0833

(52) U.S. Cl. CPC H04W 56/0015; H04L 5/0044; H04W 74/0833

(57) ABSTRACT

Various aspects of the present disclosure generally relate to wireless communication. In some aspects, a user equipment (UE) may receive one or more configuration messages indicating a configuration for candidate synchronization signal (SS) / physical broadcast channel (PBCH) blocks (SSBs) and whether one or more SSBs, according to the configuration for the candidate SSBs, are transmitted. The method may include transmitting an uplink message in a valid transmission occasion that is mapped to an SSB of the one or more SSBs, where a mapping and a validity of the valid transmission occasion are associated with the one or more configuration messages.

### PRIORITY INFORMATION

The present Application for Patent claims priority under 35 U.S.C. §119 to U.S. Provisional Patent Application No. 63/777,312, filed on Mar. 25, 2025, entitled “TECHNIQUES FOR PHYSICAL RANDOM ACCESS CHANNEL OCCASION IN CELLS WITH ADAPTIVE SYNCHRONIZATION SIGNAL BLOCK TRANSMISSION,” which is assigned to the assignee hereof and hereby expressly incorporated by reference herein.

### FIELD OF THE DISCLOSURE

Aspects of the present disclosure generally relate to wireless communication and specifically relate to techniques, apparatuses, and methods associated with physical random access channel occasion usage in cells with adaptive synchronization signal block transmission.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

A user equipment (UE) in some wireless communication systems (e.g., including in new radio (NR) wireless telecommunications systems, and/or other radio access technologies (RATs) beyond NR) may perform one or more procedures for establishing a communications link with a network node that is operating as part of a wireless communication network. The UE may communicate a series of messages with the network node to establish access to the network. In some examples, establishing access to the network may be referred to as initial access. In some examples, the UE may perform a random access procedure to establish access to the wireless communication network via the network node (e.g., to establish a communication connection including an uplink connection and/or a downlink connection). In some examples, the random access procedure may also be referred to as a random access channel (RACH) procedure. In some examples, the UE may perform a RACH procedure including a four-step random access procedure or a two-step random access procedure.

As part of a four-step RACH procedure, the UE may transmit, and the network node may receive, a first message (msg1) via a physical random access channel (PRACH). The msg1 may include a PRACH preamble. The UE may receive, and the network node may transmit, a second message (Msg2) via a physical downlink control channel (PDCCH) or via a physical downlink shared channel (PDSCH) based on transmitting the msg1. The msg 2 may include a random access response (RAR) message that schedules a physical uplink shared channel (PUSCH) transmission by the UE. For example, the msg2 may indicate and/or allocate uplink resources via which the UE may transmit a PUSCH message. The UE may transmit, and the network node may receive, a third message (msg3) including the PUSCH message and/or the UE may transmit, and the network node may receive, the msg3 via the PUSCH resources. The UE may receive, and the network node may transmit, a fourth message (msg4) that includes a contention resolution message via the PDCCH or PDSCH. For example, the UE may analyze the contention resolution message to identify whether the msg4 includes identification information (e.g., a radio network temporary identifier) that matches with the identification information of the UE (e.g., as opposed to identification information associated with a different UE). If the msg4 includes identification information associated with the UE, the UE may proceeds with establishing the connection. Otherwise, the UE may restart the four-step RACH procedure, for example, by retransmitting the msg1 and/or transmitting a second msg1.

As part of a two-step RACH procedure, the UE may transmit, and the network node may receive, a first message (msgA) including a PRACH preamble and including content similar to the content of the msg3 of the four-step RACH procedure, described above. The msgA transmission may include two transmissions. For example, a first transmission may include a PRACH preamble via the PRACH, and may include timing information for uplink transmissions (e.g., timing information that enables the network node to set timing advance parameters). A second transmission may include the remaining content of the msgA. For example, the msgA may additionally include a payload (e.g., a data payload) transmitted via the PUSCH that includes at least the Msg3 contents. In some examples, the UE may transmit, and the network node may receive, a second message (MsgB) including content similar to the contents of Msg2 and/or Msg4 of the four-step RACH procedure.

### SUMMARY

Some aspects described herein relate to a method of wireless communication performed by a user equipment (UE). The method may include receiving a first configuration message conveying a random access channel (RACH) configuration for a transmission occasion. The method may include receiving a second configuration message conveying a configuration for candidate synchronization signal / physical broadcast channel (SS/PBCH) blocks (SSBs). The method may include receiving a third configuration message indicating whether one or more SSBs, according to the second configuration for the candidate SSBs, are transmitted. The method may include transmitting an uplink message in a valid transmission occasion that is mapped to a transmitted SSB of the one or more SSBs that are transmitted, wherein a mapping and a validity of the transmission occasion are associated with the one or more SSBs that are transmitted according to the second configuration message and the third configuration messages.

Some aspects described herein relate to a method of wireless communication performed by a network node. The method may include transmitting a first configuration message conveying a RACH configuration for a transmission occasion. The method may include transmitting a second configuration message conveying a configuration for candidate SSBs. The method may include transmitting a third configuration message indicating whether one or more SSBs, according to the second configuration for the candidate SSBs, are transmitted. The method may include

receiving an uplink message in a valid transmission occasion that is mapped to a transmitted SSB of the one or more SSBs that are transmitted, wherein a mapping and a validity of the transmission occasion are associated with the one or more SSBs that are transmitted according to the second configuration message and the third configuration messages.

Some aspects described herein relate to a UE. The UE may include a processing system. The processing system may include one or more processors and one or more code-storing memories coupled with the one or more processors. The processing system may be configured to cause the UE to receive a first configuration message conveying a RACH configuration for a transmission occasion. The processing system may be configured to cause the UE to receive a second configuration message conveying a configuration for candidate SSBs. The processing system may be configured to cause the UE to receive a third configuration message indicating whether one or more SSBs, according to the second configuration for the candidate SSBs, are transmitted. The processing system may be configured to cause the UE to transmit an uplink message in a valid transmission occasion that is mapped to a transmitted SSB of the one or more SSBs that are transmitted, wherein a mapping and a validity of the transmission occasion are associated with the one or more SSBs that are transmitted according to the second configuration message and the third configuration messages.

Some aspects described herein relate to a network node. The network node may include a processing system. The processing system may include one or more processors and one or more code-storing memories coupled with the one or more processors. The processing system may be configured to cause the network node to transmit a first configuration message conveying a RACH configuration for a transmission occasion. The processing system may be configured to cause the network node to transmit a second configuration message conveying a configuration for candidate SSBs. The processing system may be configured to cause the network node to transmit a third configuration message indicating whether one or more SSBs, according to the second configuration for the candidate SSBs, are transmitted. The processing system may be configured to cause the network node to receive an uplink message in a valid transmission occasion that is mapped to a transmitted SSB of the one or more SSBs that are transmitted, wherein a mapping and a validity of the transmission occasion are associated with the one or more SSBs that are transmitted according to the second configuration message and the third configuration messages.

Some aspects described herein relate to a non-transitory computer-readable medium that stores a set of instructions for wireless communication by a UE. The set of instructions, when executed by one or more processors of the UE, may cause the UE to receive a first configuration message conveying a RACH configuration for a transmission occasion. The set of instructions, when executed by one or more processors of the UE, may cause the UE to receive a second configuration message conveying a configuration for candidate SSBs. The set of instructions, when executed by one or more processors of the UE, may cause the UE to receive a third configuration message indicating whether one or more SSBs, according to the second configuration for the candidate SSBs, are transmitted. The set of instructions, when executed by one or more processors of the UE, may cause the UE to transmit an uplink message in a valid transmission occasion that is mapped to a transmitted SSB of the one or more SSBs that are transmitted, wherein a mapping and a validity of the transmission occasion are associated with the one or more SSBs that are transmitted according to the second configuration message and the third configuration messages.

Some aspects described herein relate to a non-transitory computer-readable medium that stores a set of instructions for wireless communication by a network node. The set of instructions, when executed by one or more processors of the network node, may cause the network node to transmit a first configuration message conveying a RACH configuration for a transmission occasion. The set of instructions, when executed by one or more processors of the network node, may cause the network node to transmit a second configuration message conveying a configuration for candidate SSBs. The set of instructions, when executed by one or more processors of the network node, may cause the network node to transmit a third configuration message indicating whether one or more SSBs, according to the second configuration for the candidate SSBs, are transmitted. The set of instructions, when executed by one or more processors of the network node, may cause the network node to receive an uplink message in a valid transmission occasion that is mapped to a transmitted SSB of the one or more SSBs that are transmitted, wherein a mapping and a validity of the transmission occasion are associated with the one or more SSBs that are transmitted according to the second configuration message and the third configuration messages.

Some aspects described herein relate to an apparatus for wireless communication. The apparatus may include means for receiving a first configuration message conveying a RACH configuration for a transmission occasion. The apparatus

may include means for receiving a second configuration message conveying a configuration for candidate SSBs. The apparatus may include means for receiving a third configuration message indicating whether one or more SSBs, according to the second configuration for the candidate SSBs, are transmitted. The apparatus may include means for transmitting an uplink message in a valid transmission occasion that is mapped to a transmitted SSB of the one or more SSBs that are transmitted, wherein a mapping and a validity of the transmission occasion are associated with the one or more SSBs that are transmitted according to the second configuration message and the third configuration messages.

Some aspects described herein relate to an apparatus for wireless communication. The apparatus may include means for transmitting a first configuration message conveying a RACH configuration for a transmission occasion. The apparatus may include means for transmitting a second configuration message conveying a configuration for candidate SSBs. The apparatus may include means for transmitting a third configuration message indicating whether one or more SSBs, according to the second configuration for the candidate SSBs, are transmitted. The apparatus may include means for receiving an uplink message in a valid transmission occasion that is mapped to a transmitted SSB of the one or more SSBs that are transmitted, wherein a mapping and a validity of the transmission occasion are associated with the one or more SSBs that are transmitted according to the second configuration message and the third configuration messages.

Some aspects described herein relate to a method of wireless communication performed by a UE. The method may include receiving one or more configuration messages indicating a configuration for candidate SSBs and whether one or more SSBs, according to the configuration for the candidate SSBs, are transmitted. The method may include transmitting an uplink message in a valid transmission occasion that is mapped to an SSB of the one or more SSBs, where a mapping and a validity of the valid transmission occasion are associated with the one or more configuration messages.

Some aspects described herein relate to a UE. The UE may include a processing system. The processing system may include one or more processors and one or more code-storing memories coupled with the one or more processors. The processing system may be configured to cause the UE to receive one or more configuration messages indicating a configuration for candidate SSBs and whether one or more SSBs, according to the configuration for the candidate SSBs, are transmitted.

The processing system may be configured to cause the UE to transmit an uplink message in a valid transmission occasion that is mapped to an SSB of the one or more SSBs, where a mapping and a validity of the valid transmission occasion are associated with the one or more configuration messages.

Some aspects described herein relate to a non-transitory computer-readable medium that stores a set of instructions for wireless communication by a UE. The set of instructions, when executed by one or more processors of the UE, may cause the UE to receive one or more configuration messages indicating a configuration for candidate SSBs and whether one or more SSBs, according to the configuration for the candidate SSBs, are transmitted. The set of instructions, when executed by one or more processors of the UE, may cause the UE to transmit an uplink message in a valid transmission occasion that is mapped to an SSB of the one or more SSBs, where a mapping and a validity of the valid transmission occasion are associated with the one or more configuration messages.

Some aspects described herein relate to an apparatus for wireless communication. The apparatus may include means for receiving one or more configuration messages indicating a configuration for candidate SSBs and whether one or more SSBs, according to the configuration for the candidate SSBs, are transmitted. The apparatus may include means for transmitting an uplink message in a valid transmission occasion that is mapped to an SSB of the one or more SSBs, where a mapping and a validity of the valid transmission occasion are associated with the one or more configuration messages.

Some aspects described herein relate to a method of wireless communication performed by a network node. The method may include transmitting one or more configuration messages indicating a configuration for candidate SSBs and whether one or more SSBs, according to the configuration for the candidate SSBs, are transmitted. The method may include receiving an uplink message in a valid transmission occasion that is mapped to an SSB of the one or more SSBs, where a mapping and a validity of the valid transmission occasion are associated with the one or more configuration messages.

Some aspects described herein relate to a network node. The network node may include a processing system. The processing system may include one or more processors and one or more code-storing memories coupled with the one or more processors. The processing system may be configured to cause the network node to

transmit one or more configuration messages indicating a configuration for candidate SSBs and whether one or more SSBs, according to the configuration for the candidate SSBs, are transmitted. The processing system may be configured to cause the network node to receive an uplink message in a valid transmission occasion that is mapped to an SSB of the one or more SSBs, where a mapping and a validity of the valid transmission occasion are associated with the one or more configuration messages.

Some aspects described herein relate to a non-transitory computer-readable medium that stores a set of instructions for wireless communication by a network node. The set of instructions, when executed by one or more processors of the network node, may cause the network node to transmit one or more configuration messages indicating a configuration for candidate SSBs and whether one or more SSBs, according to the configuration for the candidate SSBs, are transmitted. The set of instructions, when executed by one or more processors of the network node, may cause the network node to receive an uplink message in a valid transmission occasion that is mapped to an SSB of the one or more SSBs, where a mapping and a validity of the valid transmission occasion are associated with the one or more configuration messages.

Some aspects described herein relate to an apparatus for wireless communication. The apparatus may include means for transmitting one or more configuration messages indicating a configuration for candidate SSBs and whether one or more SSBs, according to the configuration for the candidate SSBs, are transmitted. The apparatus may include means for receiving an uplink message in a valid transmission occasion that is mapped to an SSB of the one or more SSBs, where a mapping and a validity of the valid transmission occasion are associated with the one or more configuration messages.

The systems, methods, and devices of this disclosure each have several innovative aspects, no single one of which is solely responsible for the desirable attributes disclosed herein.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and

advantages will become apparent from the description, the drawings, and the claims. Note that the relative dimensions of the following figures may not be drawn to scale.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless communication network.

FIG. 2 is a diagram illustrating an example of a synchronization signal (SS) hierarchy.

FIGS. 3A-3C are diagrams illustrating examples of SS / physical broadcast channel (PBCH) block (SSB) communications, in accordance with the present disclosure.

FIGS. 4A and 4B are diagrams illustrating an example associated with physical random access channel (PRACH) occasion (RO) usage in cells with adaptive SSB transmission, in accordance with the present disclosure.

FIG. 5 is a diagram illustrating an example process performed, for example, at a user equipment (UE) or an apparatus of a UE.

FIG. 6 is a diagram illustrating an example process performed, for example, at a network node or an apparatus of a network node.

FIG. 7 is a diagram of an example apparatus for wireless communication.

FIG. 8 is a diagram of an example apparatus for wireless communication.

### DETAILED DESCRIPTION

A synchronization signal / physical broadcast channel (SS/PBCH) block (SSB), which may also be referred to as a synchronization signal block, can convey control information that a network node uses to configure a user equipment (UE) for transmission in a cell. An always-on (AO) periodic SSB (AO-SSB) can be transmitted in a cell supporting on-demand SSB secondary cell (“Scell” or “SCell”) operations. A network node may configure parameters for on-demand (OD) SSB (OD-SSB) bursts, such as by configuring time-domain positions, system frame number (SFN) offsets, or half frame indices, among other examples. By the network node configuring the parameters, OD-SSB transmissions may coexist in a cell with AO-SSB transmissions, as described in more detail herein. When a UE is to transmit a physical random access channel (PRACH) transmission to a network node, the UE may receive a random access channel (RACH) configuration via semi-static signaling, which may include a configuration for PRACH operations. The UE may evaluate a PRACH occasion, which may also be referred to as a RACH occasion (RO), validity rule to determine whether the RO is valid or not based on a semi-static configuration of an SSB. In other words, an RO is valid if the RO satisfies a validity rule and can be used (e.g., invalid ROs may be skipped). A validity rule may include a rule that is evaluated for determining whether an RO is valid. The validity rule may be associated with an SSB periodicity (e.g., the parameter ssb-Periodicity) or an SSB position within an SSB burst of actually transmitted SSBs (e.g., the parameter ssb-PositionsInBurst). Based on evaluating the RO validity rule, the UE may perform SSB to RO mapping, by mapping ROs to transmitted SSBs in accordance with a semi-static configuration of the SSBs. The SSB to RO mapping rule may be based on a parameter, such as an SSB position within an SSB burst of actually transmitted SSBs (e.g., the parameter ssb-PositionsInBurst). Based on determining RO validity and performing SSB to RO mapping, the UE 120 may perform PRACH transmission. For contention-based random access (CBRA), the UE may determine a suitable SSB and use a corresponding RO to transmit a PRACH communication. For contention-free random access (CFRA), the UE may use a dedicated RACH configuration, SSB index, and PRACH preamble for PRACH communication.

However, the configuration or transmission of OD-SSB communications in OD-SSB Scell operation (or the transmission of additional SSB associated with dynamic adaptation of SSB burst periodicity) may result in an effect on PRACH occasion validation rules and SSB to RO mapping rules. As an example of a PRACH occasion validation rule, a rule may specify that a PRACH occasion is valid only if it does not precede an SSB in a PRACH slot and starts at least a configured quantity of symbols after a last SSB reception symbol. As an example of an SSB-to-RO mapping rule, a rule may specify that SSB indexes provided by ssb-PositionsInBurst are mapped to valid PRACH occasions in a configured order, such as first in increasing order of preamble indexes within a single PRACH occasion, then by frequency resource indexes, followed by time resource indexes within a PRACH slot, and finally by PRACH slot indexes, ensuring each SSB index is associated with at least one PRACH occasion within an association period. Because an SSB can be dynamically indicated/activated or deactivated by medium access control (MAC) control element (MAC-CE) signaling or downlink control information (DCI) signaling or by an expiration of a timer, previous static rules for evaluating a validity of an RO and mapping an SSB to an RO may result in communication collisions, dropped communications, inefficient utilization of spectrum resources, or other issues.

Various aspects relate generally to RO usage in cells with adaptive SSB transmission. Some aspects more specifically relate to transmitting an uplink message in a valid RO that is mapped to a transmitted SSB. In some aspects, a UE may determine a validity of an RO in connection with one or more SSBs that are transmitted according to an SSB configuration. In some aspects, the UE may determine a validity of an RO in connection with one or more OD-SSB parameters (e.g., the parameters od-ssb-Periodicity or od-ssb-PositionsInBurst). In some aspects, the UE may determine a validity of an RO in connection with a latest MAC-CE indicating OD-SSB transmission at or before a time that a UE receives an Scell activation command. In some aspects, the UE may use an AO-SSB configuration or an OD-SSB configuration for determining PRACH validity. In some aspects, the UE may evaluate a collision rule to determine whether to transmit a PRACH in a valid PRACH occasion.

Particular aspects of the subject matter described in this disclosure can be implemented to realize one or more of the following potential advantages. In some examples, the described techniques can be used to avoid collisions between communications in cells with dynamic SSB adaptation. Additionally, or alternatively, the described techniques can be used to reduce a likelihood of dropped communications or improve spectral efficiency. In some aspects, by specifying one or more rules, the described techniques can be used to maintain synchronization between a UE and a network node by ensuring that the UE and the network node behave deterministically with respect to a network condition.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

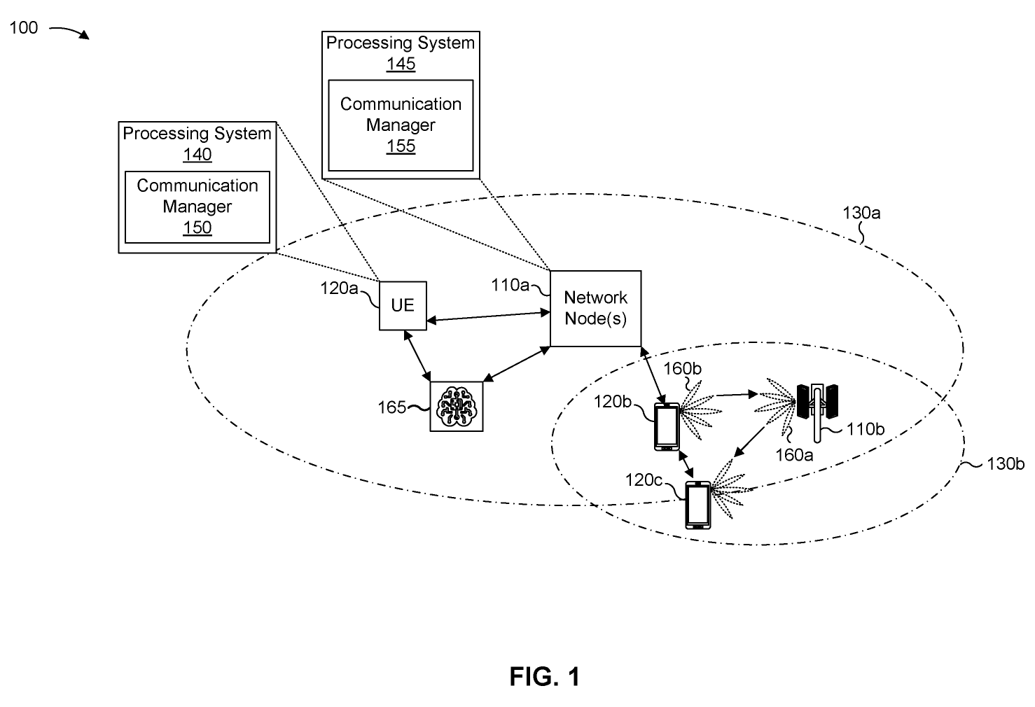

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110.

Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, the UE 120 may include a communication manager 150. As described in more detail elsewhere herein, the communication manager 150 may receive a first configuration message conveying a RACH configuration for a transmission occasion; receive a second configuration message conveying a configuration for candidate SSBs; receive a third configuration message indicating whether one or more SSBs, according to the second configuration for the candidate SSBs, are transmitted; and transmit an uplink message in a valid transmission occasion that is mapped to a transmitted SSB of the one or more SSBs that are transmitted, wherein a mapping and a validity of the transmission occasion are associated with the one or more SSBs that are transmitted according to the second configuration message and the third configuration messages. Additionally, or alternatively, the communication manager 150 may perform one or more other operations described herein.

In some aspects, the network node 110 may include a communication manager 155. As described in more detail elsewhere herein, the communication manager 155 may transmit a first configuration message conveying a RACH configuration for a transmission occasion; transmit a second configuration message conveying a configuration for candidate SSBs; transmit a third configuration message indicating whether one or more SSBs, according to the second configuration for the candidate SSBs, are transmitted; and receive an uplink message in a valid transmission occasion that is mapped to a transmitted SSB of the one or more SSBs that are transmitted, wherein a mapping and a validity of the transmission occasion are associated with the one or more SSBs that are transmitted according to the second configuration message and the third configuration messages. Additionally, or alternatively, the communication manager 155 may perform one or more other operations described herein.

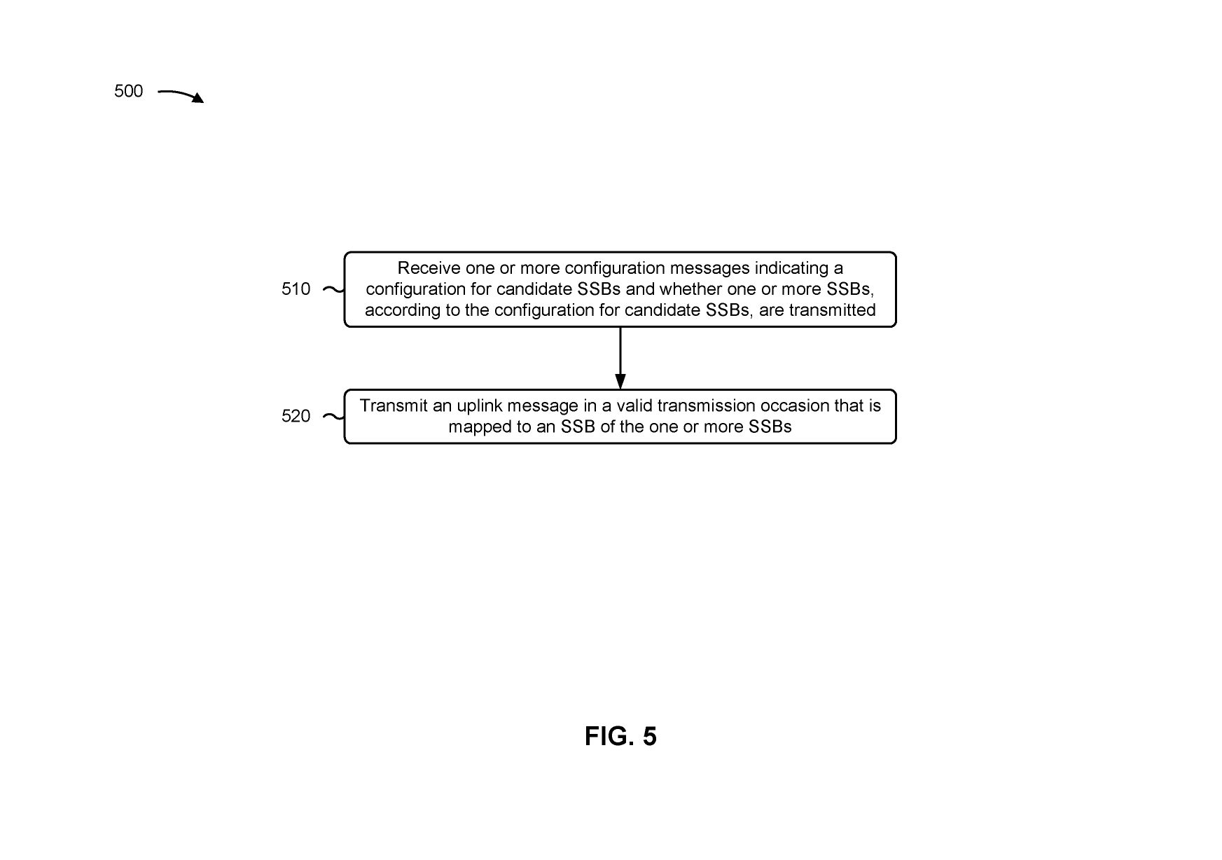

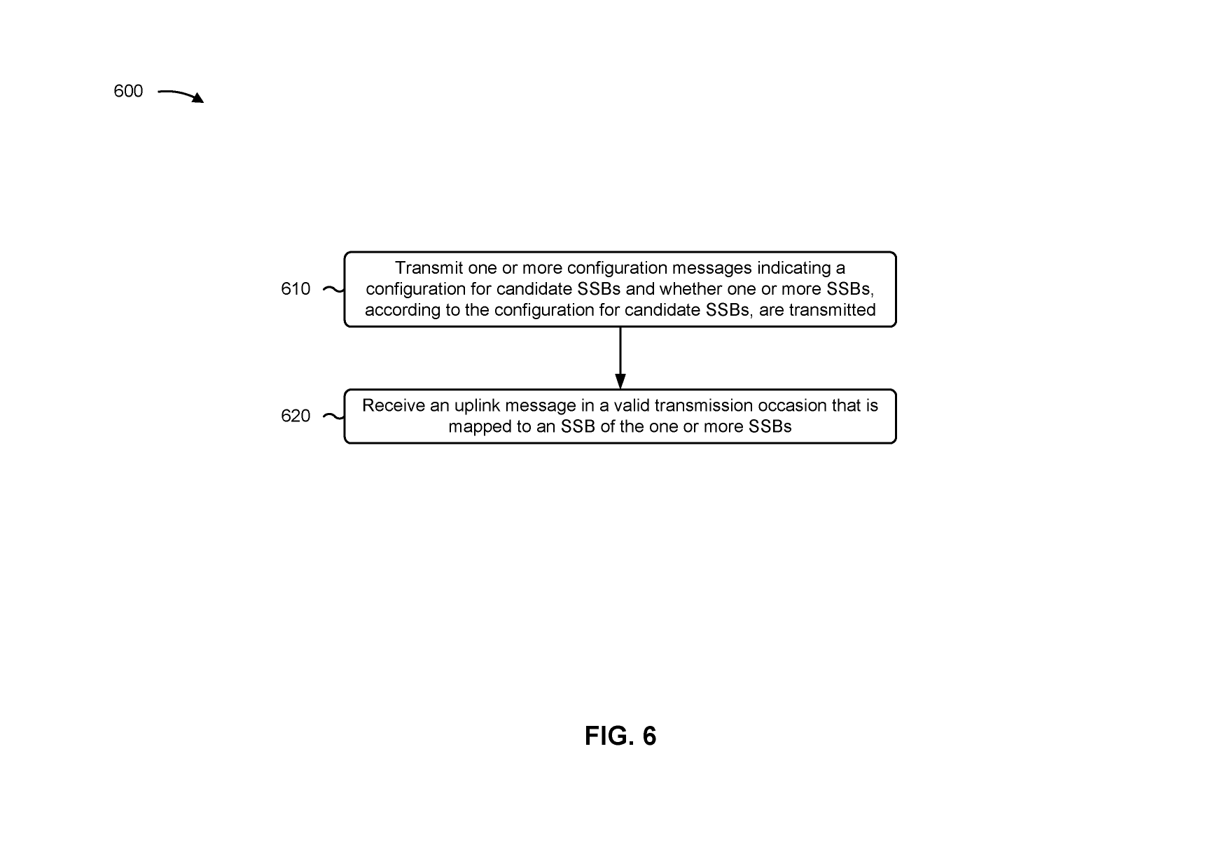

The network node 110, the processing system 145 of the network node 110, the UE 120, the processing system 140 of the UE 120, or any other component(s) of FIG. 1 may implement one or more techniques or perform one or more operations associated with RO usage in cells with adaptive SSB transmission, as described in more detail elsewhere herein. For example, the processing system 145 of the network node 110, or the processing system 140 of the UE 120 may perform or direct operations of, for example, process 500 of FIG. 5, process 600 of FIG. 6, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 500 of FIG. 5, process 600 of FIG. 6, or other processes as described herein. In some examples, executing instructions may include running the instructions, converting the instructions, compiling the instructions, or interpreting the instructions, among other examples.

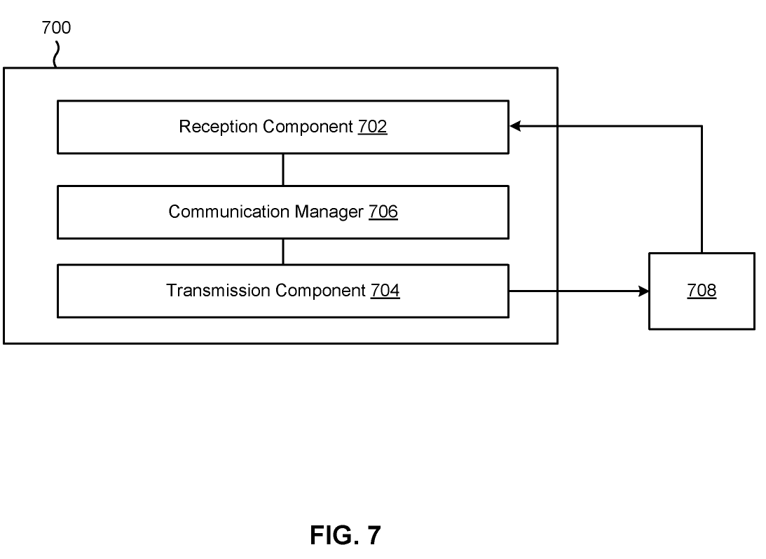

In some aspects, the UE 120 includes means for receiving a first configuration message conveying a RACH configuration for a transmission occasion; means for receiving a second configuration message conveying a configuration for candidate SSBs; means for receiving a third configuration message indicating whether one or more SSBs, according to the second configuration for the candidate SSBs, are transmitted; or means for transmitting an uplink message in a valid transmission occasion that is mapped to a transmitted SSB of the one or more SSBs that are transmitted, wherein a mapping and a validity of the transmission occasion are associated with the one or more SSBs that are transmitted according to the second configuration message and the third configuration messages. The means for the UE 120 to perform operations described herein may include, for example, one or more of communication manager 150, processing system 140, a radio, one or more RF chains, one or more transceivers, one or more antennas, one or more modems, a reception component (for example, reception component 702 depicted and described in connection with FIG. 7), or a transmission component (for example, transmission component 704 depicted and described in connection with FIG. 7), among other examples.

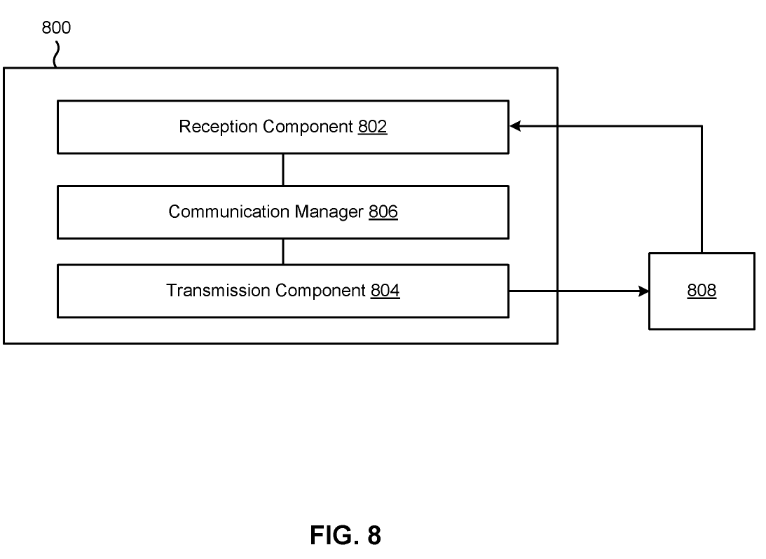

In some aspects, the network node 110 includes means for transmitting a first configuration message conveying a RACH configuration for a transmission occasion; means for transmitting a second configuration message conveying a configuration for candidate SSBs; means for transmitting a third configuration message indicating whether one or more SSBs, according to the second configuration for the candidate SSBs, are transmitted; or means for receiving an uplink message in a valid transmission occasion that is mapped to a transmitted SSB of the one or more SSBs that are transmitted, wherein a mapping and a validity of the transmission occasion are associated with the one or more SSBs that are transmitted according to the second configuration message and the third configuration messages. The means for the network node to perform operations described herein may include, for example, one or more of communication manager 155, processing system 145, a radio, one or more RF chains, one or more transceivers, one or more antennas, one or more modems, a reception component (for example, reception component 802 depicted and described in connection with FIG. 8), or a transmission component (for example, transmission component 804 depicted and described in connection with FIG. 8), among other examples.

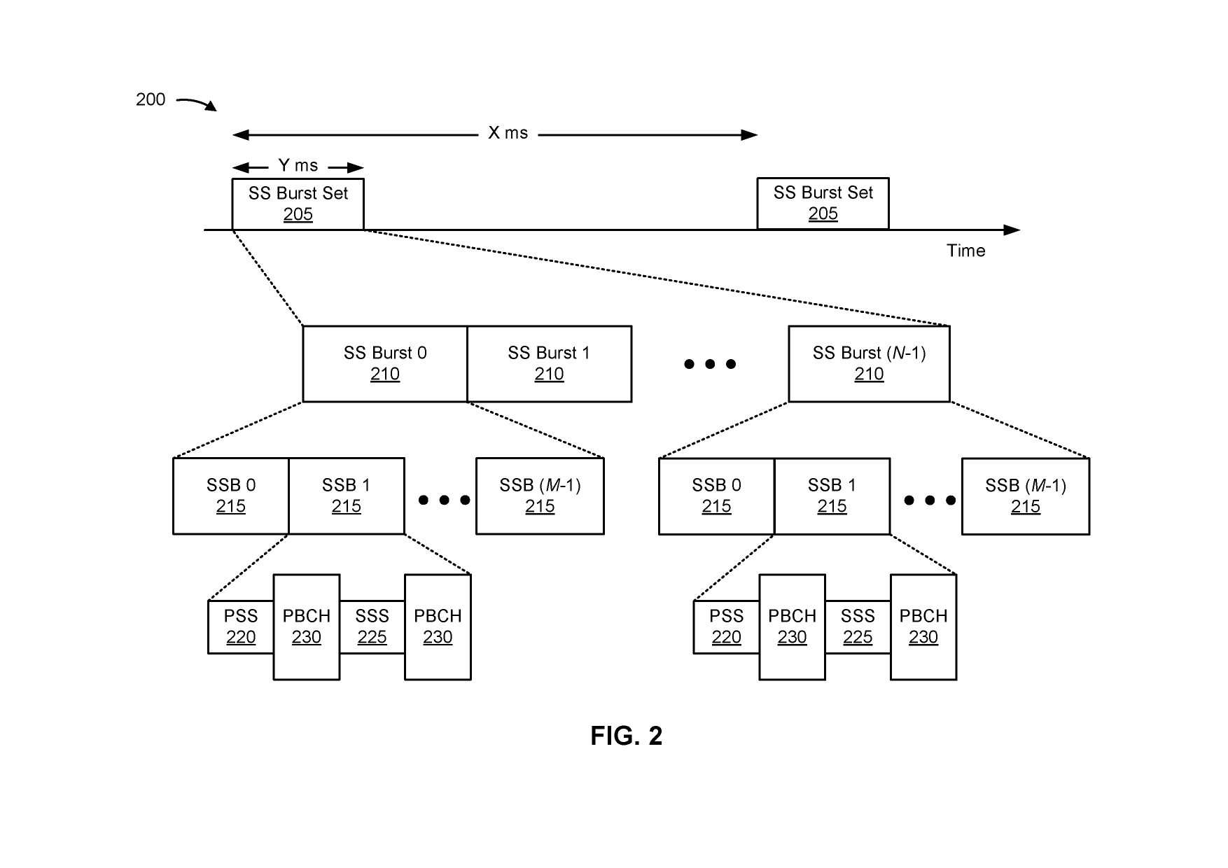

FIG. 2 is a diagram illustrating an example 200 of a synchronization signal (SS) hierarchy. As shown in FIG. 2, the SS hierarchy may include an SS burst set 205, which may include multiple SS bursts 210, shown as SS burst 0 through SS burst N-1, where N is a maximum number of repetitions of the SS burst 210 that may be transmitted by one or more network nodes. As further shown, each SS burst 210 may include one or more SS blocks (SSBs) 215, shown as SSB 0 through SSB M-1, where M is a maximum number of SSBs 215 that can be carried by an SS burst 210. In some aspects, different SSBs 215 may be beam-formed differently (e.g., transmitted using different beams), and may be used for cell search, cell acquisition, beam management, or beam selection (e.g., as part of an initial network access procedure). An SS burst set 205 may be periodically transmitted by a wireless node (e.g., a network node 110), such as every X milliseconds, as shown in FIG. 2. In some aspects, an SS burst set 205 may have a fixed or dynamic length, shown as Y milliseconds in FIG. 2. In some cases, an SS burst set 205 or an SS burst 210 may be referred to as a discovery reference signal (DRS) transmission window or an SSB measurement time configuration (SMTC) window.

In some aspects, an SSB 215 may include resources that carry a primary synchronization signal (PSS) 220, a secondary synchronization signal (SSS) 225, or a physical broadcast channel (PBCH) 230. In some aspects, multiple SSBs 215 are included in an SS burst 210 (e.g., with transmission on different beams), and the PSS 220, the SSS 225, or the PBCH 230 may be the same across each SSB 215 of the SS burst 210. In some aspects, a single SSB 215 may be included in an SS burst 210. In some aspects, the SSB 215 may be at least four symbols (e.g., OFDM symbols) in length, where each symbol carries one or more of the PSS 220 (e.g., occupying one symbol), the SSS 225 (e.g., occupying one symbol), or the PBCH 230 (e.g., occupying two symbols). In some aspects, an SSB 215 may be referred to as an SS/PBCH block.

In some aspects, the symbols of an SSB 215 are consecutive, as shown in FIG. 2. In some aspects, the symbols of an SSB 215 are non-consecutive. Similarly, in some aspects, one or more SSBs 215 of the SS burst 210 may be transmitted in consecutive radio resources (e.g., consecutive symbols) during one or more slots. Additionally, or alternatively, one or more SSBs 215 of the SS burst 210 may be transmitted in non-consecutive radio resources.

In some aspects, the SS bursts 210 may have a burst period, and the SSBs 215 of the SS burst 210 may be transmitted by a wireless node (e.g., a network node 110) according to the burst period. In this case, the SSBs 215 may be repeated during each SS burst 210. In some aspects, the SS burst set 205 may have a burst set periodicity, whereby the SS bursts 210 of the SS burst set 205 are transmitted by the wireless node according to the fixed burst set periodicity. In other words, the SS bursts 210 may be repeated during each SS burst set 205.

In some aspects, an SSB 215 may include an SSB index, which may correspond to a beam used to carry the SSB 215. A UE 120 may monitor for or measure SSBs 215 using different receive (Rx) beams during an initial network access procedure or a cell search procedure, among other examples. Based at least in part on the monitoring or measuring, the UE 120 may indicate one or more SSBs 215 with a best signal parameter (e.g., a reference signal received power (RSRP) parameter) to a network node 110 (e.g., directly or via one or more other network nodes). The network node 110 and the UE 120 may use the one or more indicated SSBs 215 to select one or more beams to be used for communication between the network node 110 and the UE 120 (e.g., for a random access channel (RACH) procedure). Additionally, or alternatively, the UE 120 may use the SSB 215 or the SSB index to determine a cell timing for a cell via which the SSB 215 is received (e.g., a serving cell).

As indicated above, FIG. 2 is provided as an example. Other examples may differ from what is described with regard to FIG. 2.

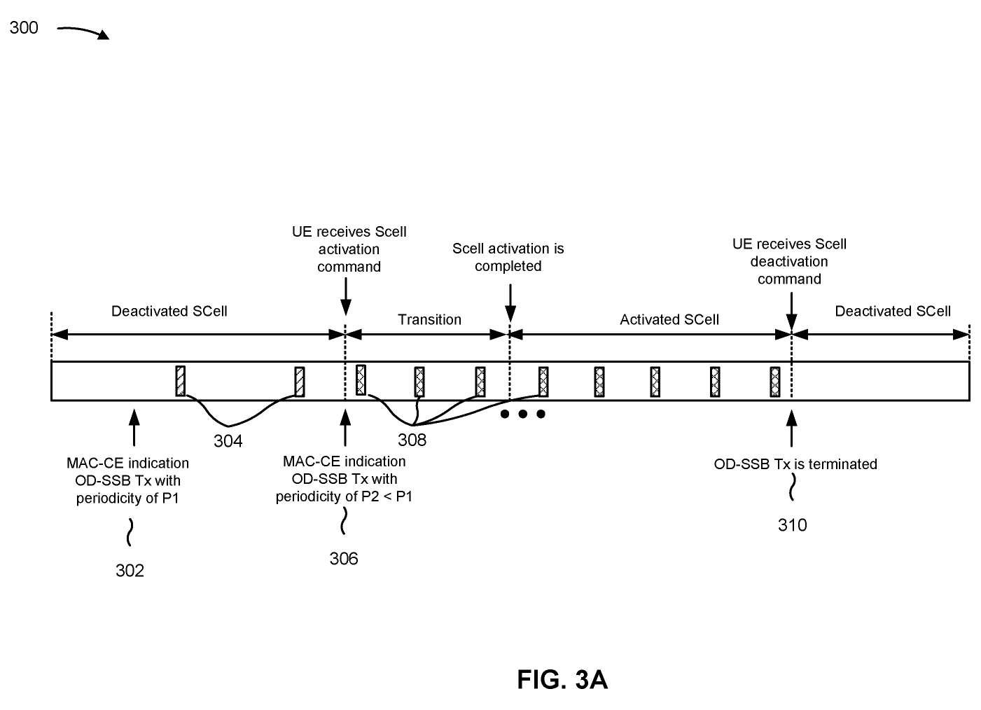

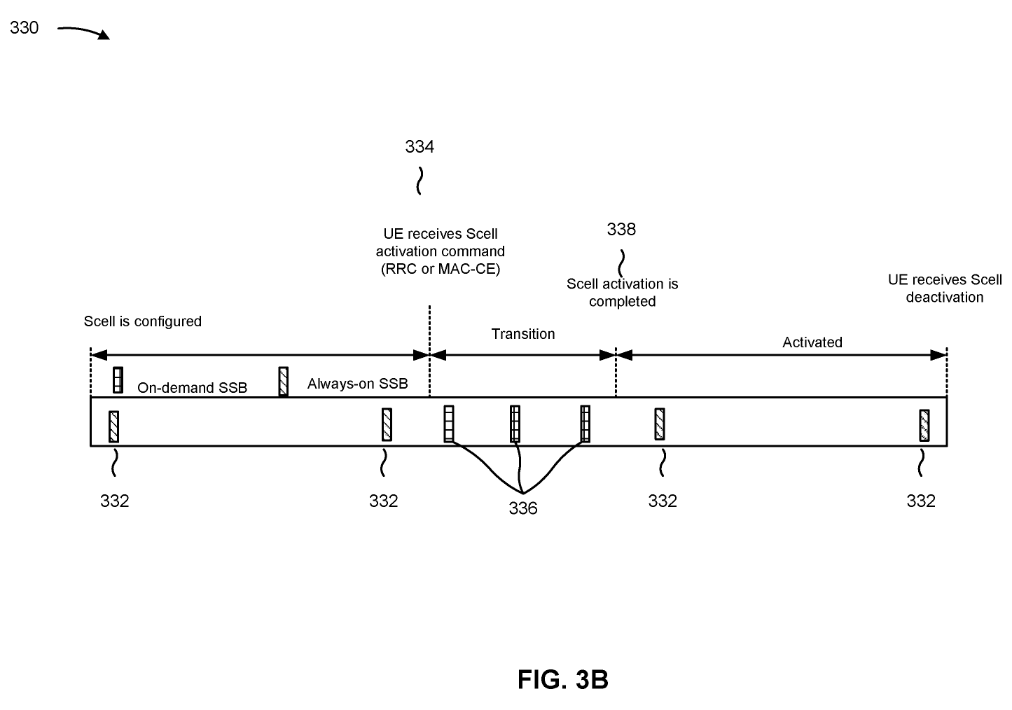

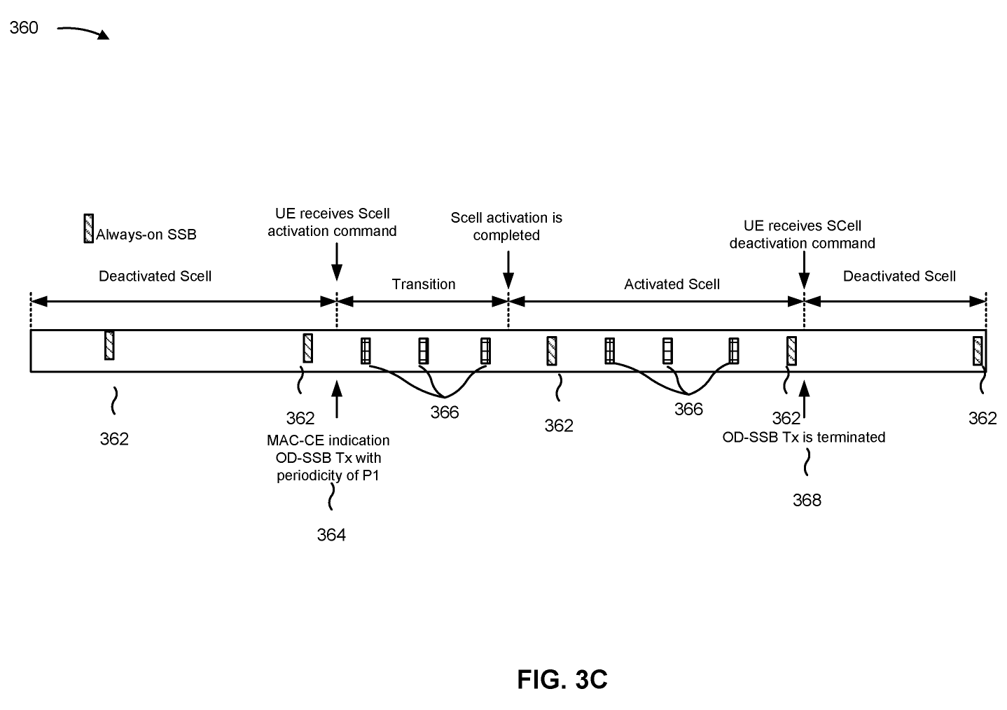

FIGS. 3A-3C are diagrams illustrating examples of SSB communications, in accordance with the present disclosure.

As shown in FIG. 3A, in example 300 of OD-SSB transmission, and as shown by reference number 302, a network node 110 may transmit and a UE 120 may receive a medium access control (MAC) control element (MAC-CE) indicating an OD-SSB transmission with a configured periodicity of P1. For example, the UE 120 may receive the MAC-CE on a primary cell (PCell), which may indicate a transmission of an on- demand SSB. As shown by reference number 304, the network node 110 may transmit an SSB in accordance with the MAC-CE configuring the OD-SSB transmission with the periodicity of P1. As shown by reference number 306, the network node 110 may transmit, and the UE 120 may receive, an Scell activation command and a MAC-CE indicating an OD-SSB transmission with a new periodicity of P2, where P2 < P1. The network node 110 may transmit one or more SSBs, as shown by reference number 308, which may occur during a transition period (e.g., which starts when the UE 120 receives the Scell activation command) and after an Scell has been activated. The SSBs are transmitted with the periodicity of P2 (e.g., the network node 110 stops transmitting the SSBs with the periodicity of P1). As shown by reference number 310, when the UE 120 receives an Scell deactivation command, the UE 120 may deactivate the Scell and the OD-SSB transmission with the periodicity of P2 may cease.

As shown in FIG. 3B, example 330 illustrates AO-SSBs being transmitted in a cell supporting OD-SSB Scell operation. For example, a network node 110 may transmit and a UE 120 may receive, when an Scell is configured but not activated, an AO-SSB on a PCell with a configured periodicity, as shown by reference number 332. As shown by reference number 334, when the UE 120 receives an Scell activation command (e.g., via radio resource control (RRC) signaling or MAC-CE) which triggers Scell activation and, as shown by reference number 336, transmission of a set of OD-SSBs by the network node 110. The OD-SSBs are transmitted during a transition period for Scell activation, but, as shown by reference number 338, when the Scell activation is complete, the network node 110 proceeds with transmitting the AO-SSBs according to the configured periodicity.

As shown in FIG. 3C, example 360 illustrates AO-SSBs being transmitted in a cell supporting OD-SSB Scell operation with OD-SSBs configured. As shown by reference number 362, the network node 110 transmits a set of AO-SSBs with a configured periodicity. As shown by reference number 364, the UE 120 receives an Scell activation command and a MAC-CE indicating OD-SSB transmission with a periodicity P1. The OD-SSB transmission occurs during the Scell transition period and continues when the Scell is activated, as shown by reference number 366. As shown by reference number 368, when the UE 120 receives an Scell deactivation command, OD-SSB transmission with the periodicity P1 is terminated (but AO-SSB transmission continues, as shown).

As indicated above, FIGS. 3A-3C are provided as examples. Other examples may differ from what is described with respect to FIGS. 3A-3C.

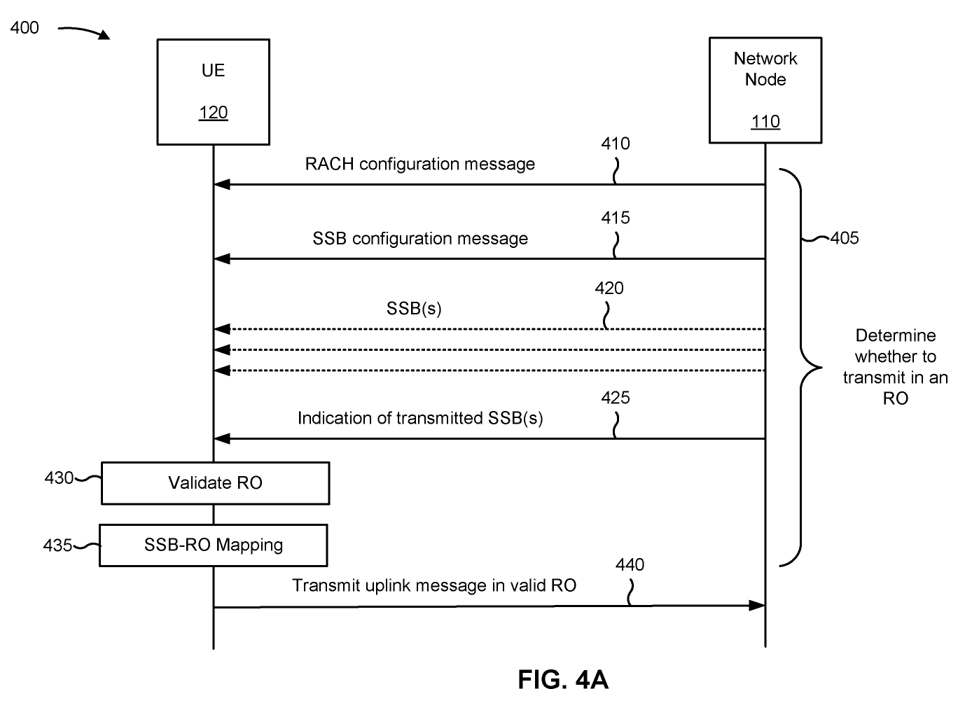

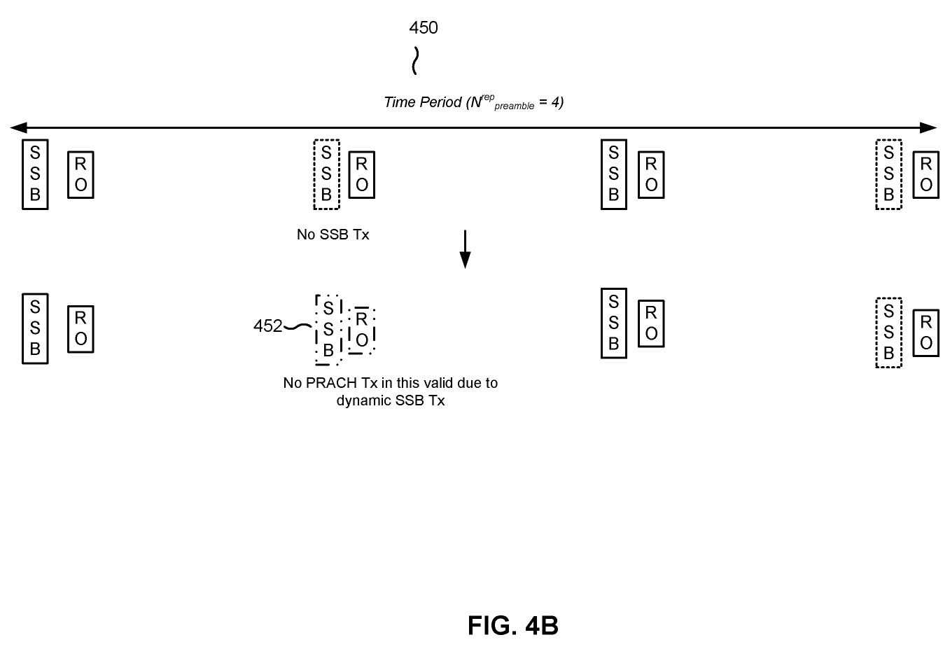

FIGS. 4A and 4B are diagrams illustrating an example 400 associated with RO usage in cells with adaptive SSB transmission, in accordance with the present disclosure. As shown in FIG. 4A, example 400 includes communication between a network node 110 and a UE 120.

As further shown in FIG. 4A, and by reference number 405, the UE 120 may determine whether to transmit in a PRACH occasion (which may be referred to as an “RO”). For example, the UE 120 may identify a PRACH occasion and may use configuration information, such as is included in one or more configuration messages, to evaluate one or more rules and determine whether the UE 120 can transmit an uplink message, such as a PRACH transmission, in the PRACH occasion.

In some aspects, the configuration information may include a first configuration message conveying RACH configuration information, as shown by reference number 410. For example, the UE 120 may receive configuration information identifying a set of RACH parameters, as described in more detail herein. In some aspects, the configuration information may include a second configuration message conveying a configuration for a set of SSBs, as shown by reference number 415. For example, the UE 120 may receive configuration information configuring a set of candidate SSBs (e.g., possible SSBs that can be selected or used). In some aspects, one or more of the set of candidate SSBs may be transmitted. For example, the network node 110 may transmit one or more SSBs 420 to the UE 120, as shown. In some aspects, the configuration information may include a third configuration message conveying an indication of whether one or more SSBs, configured in accordance with the second configuration message, were transmitted, as shown by reference number 425. For example, the UE 120 may receive an indication of whether the one or more SSBs 420 were transmitted.

In some aspects, to determine whether to transmit an uplink message in a PRACH occasion, the UE 120 may validate the PRACH occasion, as shown by reference number 430. In some aspects, to determine whether to transmit an uplink message in a PRACH occasion, the UE 120 may perform SSB-to-RO mapping, as shown by reference number 435. For example, the UE 120 may map one or more SSBs to one or more valid PRACH occasions to identify a PRACH occasion, corresponding to a received SSB, in which to transmit an uplink message.

In some aspects, the UE 120 may validate a PRACH occasion for OD-SSB transmission without AO-SSB transmission in a cell. For example, when the UE 120 receives RRC-based indication of OD-SSB transmission, the UE 120 may evaluate a PRACH occasion validation rule and an SSB-to-RO mapping rule, based on one or more OD-SSB parameters (e.g., od-SSB-Periodicity or od-ssb-PositionsInBurst) provided by the OD-SSB configuration (e.g., od-ssb-Config) in the RRC signaling. For example, if the OD-SSB configuration in the RRC signaling specifies an od-SSB-Periodicity of a particular value and od-ssb-PositionsInBurst indicates a pair of SSB indexes, the UE 120 may validate a PRACH occasion such that a PRACH occasion is considered valid if the PRACH occasion occurs at least N_{gap} symbols after the last reception of an SSB at either of the pair of indexes within the particular value of the periodicity window. Furthermore, the UE 120 may apply an SSB-to-RO mapping rule such that PRACH occasions within each periodicity window are mapped in order to a first SSB index of the pair of SSB indexes first, then to a second SSB index of the pair of SSB indexes, based on respective positions in the burst, ensuring that each PRACH occasion is associated with a transmitted SSB in accordance with the current OD-SSB configuration. Similarly, when the UE 120 receives MAC-CE-based indication of OD-SSB transmission, the UE 120 may evaluate a PRACH occasion validation rule and an SSB-to-RO mapping rule based on OD-SSB parameters provided by the OD-SSB configuration in RRC signaling and based on a latest MAC-CE indicating an OD-SSB transmission. The latest MAC-CE may include a MAC-CE that is received by the UE 120 at or before a time at which the UE 120 receives an Scell activation command. For example, the network node 110 may transmit a MAC-CE-based indication of an OD-SSB transmission. In this example, an addition or removal of an SSB as a result of the transmitted MAC-CE may not be considered with respect to determining PRACH occasion validity or mapping. Additionally, or alternatively, rather than a latest MAC-CE, the UE 120 may receive a configuration message indicating whether one or more SSBs are transmitted in a first MAC-CE occurring after reception of the configuration for the SSBs.

In some aspects, the UE 120 may validate a PRACH occasion for OD-SSB transmission with AO-SSB transmission in a cell. For example, when the UE 120 receives RRC-based indication of OD-SSB transmission, the UE 120 may evaluate a PRACH occasion validation rule and an SSB-to-RO mapping rule, based on either an AO-SSB configuration or an OD-SSB configuration (but not both). Alternatively, the UE 120 may evaluate a PRACH occasion validation rule and an SSB-to-RO mapping rule, based on both the AO-SSB configuration and the OD-SSB configuration. Additionally, or alternatively, when the UE 120 receives MAC-CE-based indication of OD-SSB transmission, the UE 120 may ignore the MAC-CE-based indication of the OD-SSB transmission for evaluating PRACH occasion validity or SSB-to-RO mapping. In other words, the OD-SSB transmissions triggered by a MAC-CE indication are not considered when evaluating PRACH occasion validity or SSB-to-RO mapping. In this case, the UE 120 evaluates PRACH occasion validity and SSB-to-RO mapping based on an SSB configuration that is included in connection with Scell configuration signaling (e.g., an AO-SSB configuration). In some aspects, a UE 120 may receive DCI associated with SSB burst periodicity dynamic adaptation. For example, the UE 120 may receive DCI (e.g., DCI format 2-9 among other examples) that dynamically configures an SSB burst periodicity of one or more configured SSBs, but may ignore the DCI configuration with respect to determining PRACH occasion validity or SSB-to-RO mapping. In this case, the UE 120 evaluates PRACH occasion validity and SSB-to-RO mapping based on an SSB configuration that is included in connection with Scell configuration signaling (e.g., an AO-SSB configuration).

In some aspects, the UE 120 may evaluate a collision rule when determining whether to transmit an uplink message in a PRACH occasion. For example, although MAC-CE-triggered OD-SSB transmission or DCI-triggered SSB burst periodicity adaptation may not affect an evaluation of PRACH occasion validity or SSB-to-RO mapping, as described above, the UE 120 may use configuration information of the MAC-CE or the DCI in determining whether a collision occurs with respect to a valid PRACH occasion. A collision may occur when the UE 120 determines that a first transmission is scheduled concurrent with a second transmission (e.g., in the same communication resources). Accordingly, in some aspects, the UE 120 may forgo transmission in a valid PRACH occasion if the valid PRACH occasion precedes an SSB in a PRACH slot and does not start at least a configured quantity of symbols (e.g., a parameter N_{gap}) after a last SSB reception symbol. In this case, the UE 120 may include MAC-CE-triggered OD-SSB transmissions or DCI-triggered SSB burst periodicity adaptation affected SSB transmissions when determining whether a collision occurs. When the UE 120 forgoes transmission in a valid PRACH occasion, in some aspects, the UE 120 may identify another, subsequent valid PRACH occasion in which to transmit an uplink message. In some aspects, rather than a static rule that the UE 120 is to forgo transmission when a collision occurs, the UE 120 may be configured with a UE-specific configuration. In other words, some UEs 120 may be configured to transmit when a collision is scheduled to occur between a valid PRACH occasion and another SSB and other UEs 120 may be configured not to transmit when the collision is scheduled to occur. Whether the UE 120 transmits or forgoes transmission may be based on a UE-type, a UE-capability, a configured transmission priority, a communication service (e.g., a latency characteristic), or whether the UE 120 has already delayed or canceled transmitting in a valid PRACH occasion, among other examples.

In some aspects, the UE 120 may increment a quantity of preamble repetitions, for PRACH preamble repetition transmission, when the UE 120 forgoes transmitting in a valid PRACH occasion. A time period for PRACH transmission with preamble repetition assumes that the UE 120 is to transmit a quantity N^{Rep} _{preamble} in an amount of time that provides N^{Rep} _{preamble} valid PRACH occasions. However, because the UE 120 may forgo PRACH transmission (including PRACH preamble transmission), the UE 120 may transmit fewer than N^{Rep} _{preamble} PRACH preamble repetitions in the configured amount of time. FIG. 4B shows an example of a time period 450 that is configured for N^{Rep} _{preamble} = 4, but in which a dynamic SSB transmission is scheduled, resulting in a valid PRACH occasion 452 in which the UE 120 does not transmit a PRACH preamble repetition (e.g., as a result of a MAC-CE-triggered OD-SSB transmission or a DCI-triggered SSB for dynamic adaptation of SSB burst periodicity). Accordingly, in some aspects, the UE 120 may count a preamble repetition, that has not been transmitted as a result of a collision, toward the configured quantity of preamble repetitions N^{Rep} _{preamble}. In other words, in some aspects, the UE 120 may consider the configured quantity of preamble repetitions having been satisfied even though fewer than the configured quantity of preamble repetitions were actually transmitted. Alternatively, in some aspects, the UE 120 may not count a preamble repetition that is not transmitted as a result of a collision toward the configured quantity of preamble repetitions N^{Rep} _{preamble}. In this case, the UE 120 may trigger another procedure to enable subsequent transmission of additional preamble repetitions until the configured quantity is satisfied by actually transmitted preamble repetitions.

Although some aspects are described herein in terms of PRACH occasions and PRACH transmission, it is contemplated that aspects described herein may be applicable to PUSCH occasions and PUSCH transmission. For example, the UE 120 may receive one or more configuration messages conveying configuration information for PUSCH occasions, and may determine whether to transmit a PUSCH transmission in a PUSCH occasion. In some aspects, the UE 120 may determine whether a PUSCH occasion is valid or resolve a collision rule for a PUSCH in connection with transmission of an OD-SSB. For example, as described above, for RRC-based indication of an OD-SSB transmission, the UE 120 may determine whether a PUSCH occasion is valid based on OD-SSB parameters provided by the RRC signaling. In contrast, for MAC-CE-based indication of OD-SSB transmission, the UE 120 may determine whether a PUSCH occasion is valid based on OD-SSB parameters in RRC signaling and a latest MAC-CE indicating OD-SSB transmission occurring at or before a time when the UE 120 receives an Scell activation command. Additionally, or alternatively, the UE 120 may use an AO-SSB configuration, an OD-SSB configuration, or a combination thereof to validate a PUSCH occasion, as described above with respect to PRACH occasions. Similarly, when the UE 120 receives a MAC-CE based indication of OD-SSB transmission or DCI-based dynamic adaptation of SSB burst periodicity, the UE 120 may omit such triggered SSBs from a determination of PUSCH validity. Additionally, or alternatively, the UE 120 may evaluate a collision rule with respect to a PUSCH occasion and an OD-SSB transmission, as described above.

Additionally, or alternatively, the UE 120 may forgo transmission of a PUSCH communication in a PUSCH occasion when the PUSCH occasion is associated with a demodulation reference signal (DMRS) resource is not mapped to a preamble of a valid PUSCH occasion or if an associated PRACH preamble is not transmitted in connection with a PRACH occasion. In other words, when the UE 120 is not configured to transmit PRACH in a valid PRACH occasion for which there is a scheduled collision, as described above, there will be a valid PRACH occasion associated with a DMRS resource in which the UE 120 does not transmit a PRACH communication. Accordingly, the UE 120 may transmit a PUSCH in a PUSCH occasion mapping to the valid PRACH occasion.

In some aspects, the UE 120 may evaluate a collision rule, for a PRACH occasion, with respect to another type of downlink transmission. For example, the UE 120 may identify a collision when a PDCCH, PDSCH, or CSI-RS is scheduled in symbols that would overlap with a set of symbols corresponding to a valid PRACH occasion and extending N_{gap} symbols before the valid PRACH occasion. In this case, the valid PRACH occasion is a PRACH occasion in which the UE 120 is able to transmit a PRACH communication. In other words, such a valid PRACH occasion does not include PRACH occasions in which the UE 120 does not transmit the PRACH communication because of a collision between the PRACH communication and, for example, an SSB (e.g., a PRACH occasion that precedes an SSB in a PRACH slot and starts at least N_{gap} symbols after a last SSB reception symbol). When the UE 120 determines that there is a collision between a valid PRACH occasion and a PDCCH, PDSCH, or CSI-RS, the UE 120 may forgo reception of the PDCCH, PDSCH, or CSI-RS. In other words, the UE 120 may transmit the PRACH communication in the valid PRACH occasion, and does not monitor for downlink reception of a PDCCH, PDSCH, or CSI-RS.

As further shown in FIG. 4A, and by reference number 440, the UE 120 may transmit an uplink message in a valid PRACH occasion. For example, the UE 120 may transmit a PRACH communication in the valid PRACH occasion. In this case, when the UE 120 determines that there is a valid PRACH occasion and resolves one or more collision rules in favor of PRACH transmission (e.g., there is no collision with an SSB, but there may be a collision with a PDCCH, PDSCH, or CSI-RS that is resolved in favor of the PRACH transmission), the UE 120 may transmit a PRACH communication. Additionally, or alternatively, as described above, the UE 120 may transmit a PUSCH in a valid PUSCH occasion.

As indicated above, FIGS. 4A and 4B are provided as an example. Other examples may differ from what is described with respect to FIGS. 4A and 4B.

FIG. 5 is a diagram illustrating an example process 500 performed, for example, at a UE or an apparatus of a UE. Example process 500 is an example where the apparatus or the UE (e.g., UE 120) performs operations associated with RO usage in cells with adaptive SSB transmission.

As shown in FIG. 5, in some aspects, process 500 may include receiving one or more configuration messages indicating a configuration for candidate SSBs and whether one or more SSBs, according to the configuration for candidate SSBs, are transmitted (block 510). For example, the UE (e.g., using reception component 702 or communication manager 706, depicted in FIG. 7) may receive one or more configuration messages indicating a configuration for candidate SSBs and whether one or more SSBs, according to the configuration for candidate SSBs, are transmitted. In some aspects, receiving the one or more configuration messages may include receiving a first configuration message conveying a RACH configuration for a transmission occasion.

For example, the UE (e.g., using reception component 702 or communication manager 706, depicted in FIG. 7) may receive a first configuration message conveying a RACH configuration for a transmission occasion, as described above. Additionally, or alternatively, receiving the one or more configuration messages may include receiving a second configuration message conveying a configuration for candidate SSBs. For example, the UE (e.g., using reception component 702 or communication manager 706, depicted in FIG. 7) may receive a second configuration message conveying a configuration for candidate SSBs, as described above. Additionally, or alternatively, receiving the one or more configuration messages may include receiving a third configuration message indicating whether one or more SSBs, according to the second configuration for the candidate SSBs, are transmitted. For example, the UE (e.g., using reception component 702 or communication manager 706, depicted in FIG. 7) may receive a third configuration message indicating whether one or more SSBs, according to the second configuration for the candidate SSBs, are transmitted, as described above.

As further shown in FIG. 5, in some aspects, process 500 may include transmitting an uplink message in a valid transmission occasion that is mapped to an SSB of the one or more SSBs (block 520). For example, the UE (e.g., using transmission component 704 or communication manager 706, depicted in FIG. 7) may transmit an uplink message in a valid transmission occasion that is mapped to an SSB of the one or more SSBs. In some aspects, at least one of a mapping or a validity of the valid transmission occasion is associated with the one or more configuration messages. In some aspects, transmitting the uplink message may include transmitting an uplink message in a valid transmission occasion that is mapped to a transmitted SSB of the one or more SSBs that are transmitted. For example, the UE (e.g., using transmission component 704 or communication manager 706, depicted in FIG. 7) may transmit an uplink message in a valid transmission occasion that is mapped to a transmitted SSB of the one or more SSBs that are transmitted, wherein a mapping and a validity of the transmission occasion are associated with the one or more SSBs that are transmitted according to the second configuration message and the third configuration messages, as described above. In some aspects, when the one or more SSBs are transmitted, the UE may transmit an uplink message in a valid transmission occasion that is mapped to an SSB of the one or more SSBs, wherein a mapping of the valid transmission occasion to the SSB of the one or more SSBs and a validity of the valid transmission occasion are associated with the one or more configuration messages.

Process 500 may include additional aspects, such as any single aspect or any combination of aspects described below or in connection with one or more other processes described elsewhere herein.

In a first aspect, the third configuration message is included in an RRC message. For example, the UE receives the third configuration message as part of an RRC message indicating which SSBs are to be transmitted. In this way, the UE can promptly determine the set of active SSBs for PRACH occasion validation and SSB-to-RO mapping, ensuring reliable initial access and synchronization based on the most current network configuration. Alternatively, if the third configuration message is not included in an RRC message, the UE may rely on a previously received configuration or default parameters. This fallback ensures that the UE can maintain connectivity even if updated signaling is delayed, thereby supporting robust operation in scenarios with intermittent signaling.

In a second aspect, alone or in combination with the first aspect, the third configuration message is included in a most recently received MAC-CE message before a Scell activation. For example, the UE receives the third configuration message in the latest MAC-CE before Scell activation, enabling the UE to validate PRACH occasions based on the most current SSB transmission status. Alternatively, if no MAC-CE is received, the UE may proceed using the SSB configuration from RRC, ensuring continued access and minimizing connection delays.

In a third aspect, alone or in combination with one or more of the first and second aspects, the valid transmission occasion is a valid PRACH occasion, and the uplink message includes a RACH message. Additionally, or alternatively, the transmission occasion is a PRACH occasion, the valid transmission occasion is a valid PRACH occasion, and the uplink message includes a RACH message. For example, the UE transmits a RACH message during a PRACH occasion that has been validated according to the current SSB configuration, ensuring successful initial access. Alternatively, if the PRACH occasion is not validated, the UE refrains from transmitting the RACH message, thereby avoiding potential collisions and improving network efficiency.

In a fourth aspect, alone or in combination with one or more of the first through third aspects, the configuration for the candidate SSBs includes at least one of an SSB periodicity parameter, a parameter to indicate SSB positions in an SSB burst for SSB transmission, a center frequency, a subcarrier spacing, a physical cell identifier, or a quantity of SSB bursts that are to be transmitted. For example, the UE may receive a configuration message specifying an SSB periodicity parameter and SSB positions in a burst. In this way, the UE can synchronize to the cell and determine valid transmission occasions for uplink transmission. Alternatively, if these parameters are not provided, the UE may use default or previously configured values to maintain reliable connectivity.

In a fifth aspect, alone or in combination with one or more of the first through fourth aspects, process 500 includes receiving another configuration message conveying a configuration of SSBs that are periodically transmitted. Additionally, or alternatively, process 500 includes receiving a fourth configuration message conveying a configuration of SSBs that are periodically transmitted. In some aspects, the valid transmission occasion is mapped to another SSB transmission of the SSBs based at least in part on SSB indices corresponding to a set of SSB positions in the other configuration message. For example, the UE may receive a fourth configuration message specifying SSBs that are periodically transmitted, including SSB indices. In this way, the UE can map valid transmission occasions to the appropriate SSB transmissions for accurate uplink timing. Alternatively, if such configuration is absent, the UE may rely on previously received SSB configuration to maintain transmission scheduling.

In a sixth aspect, alone or in combination with one or more of the first through fifth aspects, the validity of the transmission occasion is based on SSB transmission according to the one or more configuration messages and SSB transmission according to the other configuration messages. Additionally, or alternatively, the validity of the transmission occasion is based on SSB transmission according to the third configuration message and SSB transmission according to the fourth configuration message. For example, the UE may determine the validity of a transmission occasion based on SSB transmissions indicated in both the third and fourth configuration messages. In this way, the UE ensures that uplink transmissions occur only during valid occasions mapped to active SSBs. Alternatively, if only one configuration message is available, the UE may base transmission occasion validity on the one configuration message.

In a seventh aspect, alone or in combination with one or more of the first through sixth aspects, the valid transmission occasion is associated with a collision rule, wherein the collision rule relates to at least one of whether the valid transmission occasion is within a threshold gap of the one or more SSBs transmitted according to the one or more configuration messages. Additionally, or alternatively, the valid transmission occasion is associated with a collision rule, wherein the collision rule relates to whether the valid transmission occasion is within a threshold gap between two adjacent SSBs of the one or more SSBs transmitted according to the third configuration message. For example, the UE may apply a collision rule to determine if a valid transmission occasion falls within a threshold gap of one or more transmitted SSBs, as specified in the configuration messages. In this way, the UE avoids uplink transmissions that could interfere with SSB reception. Alternatively, if the threshold gap is not defined, the UE may use a default value to maintain transmission continuity.

In an eighth aspect, alone or in combination with one or more of the first through seventh aspects, the third configuration message is received MAC-CE or DCI signaling. For example, the UE may receive the third configuration message via MAC-CE or DCI signaling from the network node. In this way, the UE can promptly update transmission scheduling based on dynamic network conditions. Alternatively, if such signaling is not received, the UE may rely on previously configured parameters to continue operation.

In a ninth aspect, alone or in combination with one or more of the first through eighth aspects, a preamble repetition transmission, for the uplink message, not occurring in the valid transmission occasion is included in a configured quantity of preamble repetitions. For example, the UE may receive the third configuration message through MAC-CE or DCI signaling. In this way, the UE can dynamically adjust its transmission timing based on updated network instructions.

In a tenth aspect, alone or in combination with one or more of the first through ninth aspects, a preamble repetition transmission, for the uplink message, not occurring in the valid transmission occasion is not included in a configured quantity of preamble repetitions. For example, the UE may exclude any preamble repetition transmission that does not occur in a valid transmission occasion from the configured quantity of preamble repetitions. In this way, the UE ensures that only successfully transmitted repetitions are counted toward the required total.

In an eleventh aspect, alone or in combination with one or more of the first through tenth aspects, the valid transmission occasion is a valid PUSCH occasion, and the uplink message is a PUSCH message. Additionally, or alternatively, the transmission occasion is a PUSCH occasion, the valid transmission occasion is a valid PUSCH occasion, and the uplink message is a PUSCH message. For example, the UE may identify a valid PUSCH occasion and transmit a PUSCH message during that occasion. In this way, the UE ensures uplink data is sent only when transmission resources are properly allocated.

In a twelfth aspect, alone or in combination with one or more of the first through eleventh aspects, whether the uplink message is transmitted in the valid transmission occasion is associated with whether a demodulation reference signal resource is mapped to a preamble of another occasion that is valid but in which the UE does not transmit in connection with an SSB transmission according to the one or more configuration messages. Additionally, or alternatively, whether the uplink message is transmitted in the valid transmission occasion is associated with whether a demodulation reference signal resource is mapped to a preamble of another occasion that is valid but in which the UE does not transmit in connection with an SSB transmission according to the third configuration message. For example, the UE may determine whether to transmit an uplink message in a valid transmission occasion based on whether a demodulation reference signal resource is mapped to a preamble of another valid occasion where transmission did not occur due to SSB configuration. In this way, the UE coordinates its transmissions to maintain proper mapping between reference signals and transmission occasions.

In a thirteenth aspect, alone or in combination with one or more of the first through twelfth aspects, a collision rule is associated with whether a downlink communication is received in a slot that overlaps with the valid transmission occasion.

In a fourteenth aspect, alone or in combination with one or more of the first through thirteenth aspects, in accordance with the collision rule, the UE is to forgo reception in the slot. For example, the UE may apply a collision rule to determine whether downlink communication is received in a slot that overlaps with a valid transmission occasion. In this way, the UE can avoid interference between uplink transmissions and downlink receptions.

In a fifteenth aspect, alone or in combination with one or more of the first through fourteenth aspects, in accordance with the collision rule, the UE is optionally able to receive the downlink communication in the slot. For example, the UE may be configured to optionally receive downlink communication in a slot that overlaps with a valid transmission occasion, according to the collision rule. In this way, the UE can flexibly manage simultaneous uplink and downlink activities based on network requirements.

In a sixteenth aspect, alone or in combination with one or more of the first through fifteenth aspects, the valid transmission occasion is validated based at least in part on the configuration for the candidate SSBs in the one or more configuration messages. For example, the UE may be permitted to receive downlink communication in a slot that overlaps with a valid transmission occasion, as specified by the collision rule. In this way, the UE supports simultaneous reception and transmission when network conditions allow.

In a seventeenth aspect, alone or in combination with one or more of the first through sixteenth aspects, the transmission occasion is mapped to the transmitted SSB based at least in part on SSB indices corresponding to a set of SSB positions in the one or more configuration messages. For example, the UE may map a transmission occasion to a transmitted SSB based on SSB indices specified in the configuration messages. In this way, the UE ensures that uplink transmissions are accurately aligned with the corresponding SSB resources.

In an eighteenth aspect, alone or in combination with one or more of the first through seventeenth aspects, the validity of the valid transmission occasion is based on SSB transmission according to the one or more configuration messages and SSB transmission according to the other configuration message. Additionally, or alternatively, the validity of the transmission occasion is based on SSB transmission according to the third configuration message only or SSB transmission according to the fourth configuration message only. For example, the UE may determine the validity of a transmission occasion based on SSB transmissions indicated in multiple configuration messages, or solely on the third or fourth configuration message. In this way, the UE adapts its transmission timing to reflect the most current SSB configuration provided by the network.

In a nineteenth aspect, alone or in combination with one or more of the first through eighteenth aspects, in accordance with a collision rule, the UE is to forgo transmission in the valid transmission occasion. For example, the UE may forgo transmission in a valid transmission occasion if a collision rule indicates a potential conflict with another scheduled transmission. In this way, the UE prevents interference and maintains efficient use of network resources.

In a twentieth aspect, alone or in combination with one or more of the first through eighteenth aspects, in accordance with the collision rule, the UE is optionally able to transmit in the valid transmission occasion. For example, the UE may be optionally permitted to transmit in a valid transmission occasion, as determined by the collision rule. In this way, the UE can flexibly utilize available transmission opportunities when network conditions permit.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, at a network node or an apparatus of a network node. Example process 600 is an example where the apparatus or the network node (e.g., network node 110) performs operations associated with techniques for RO usage in cells with adaptive SSB transmission.

As shown in FIG. 6, in some aspects, process 600 may include transmitting one or more configuration messages indicating a configuration for candidate SSBs and whether one or more SSBs, according to the configuration for candidate SSBs, are transmitted (block 610). For example, the network node (e.g., using transmission component 804 or communication manager 806, depicted in FIG. 8) transmit one or more configuration messages indicating a configuration for candidate SSBs and whether one or more SSBs, according to the configuration for candidate SSBs, are transmitted, as described above. In some aspects, transmitting the one or more configuration messages may include transmitting a first configuration message conveying a RACH configuration for a transmission occasion. For example, the network node (e.g., using transmission component 804 or communication manager 806, depicted in FIG. 8) may transmit a first configuration message conveying a RACH configuration for a transmission occasion, as described above. In some aspects, transmitting the one or more configuration messages may include transmitting a second configuration message conveying a configuration for candidate SSBs. For example, the network node (e.g., using transmission component 804 or communication manager 806, depicted in FIG. 8) may transmit a second configuration message conveying a configuration for candidate SSBs, as described above. In some aspects, transmitting the one or more configuration messages may include transmitting a third configuration message indicating whether one or more SSBs, according to the second configuration for the candidate SSBs, are transmitted. For example, the network node (e.g., using transmission component 804 or communication manager 806, depicted in FIG. 8) may transmit a third configuration message indicating whether one or more SSBs, according to the second configuration for the candidate SSBs, are transmitted, as described above.

As further shown in FIG. 6, in some aspects, process 600 may include receiving an uplink message in a valid transmission occasion that is mapped to an SSB of the one or more SSBs (block 620). For example, the network node (e.g., using reception component 802 or communication manager 806, depicted in FIG. 8) may receive an uplink message in a valid transmission occasion that is mapped to an SSB of the one or more SSBs, as described above. In some aspects, at least one of a mapping or a validity of the valid transmission occasion is associated with the one or more configuration messages. In some aspects, receiving the uplink message may include receiving an uplink message in a valid transmission occasion that is mapped to a transmitted SSB of the one or more SSBs that are transmitted. For example, the network node (e.g., using reception component 802 or communication manager 806, depicted in FIG. 8) may receive an uplink message in a valid transmission occasion that is mapped to a transmitted SSB of the one or more SSBs that are transmitted, wherein a mapping and a validity of the transmission occasion are associated with the one or more SSBs that are transmitted according to the second configuration message and the third configuration messages, as described above. In some aspects, when the one or more SSBs are transmitted, the network node may receive an uplink message in a valid transmission occasion that is mapped to an SSB of the one or more SSBs, wherein a mapping of the valid transmission occasion to the SSB of the one or more SSBs and a validity of the valid transmission occasion are associated with the one or more configuration messages.

Process 600 may include additional aspects, such as any single aspect or any combination of aspects described below or in connection with one or more other processes described elsewhere herein.

In a first aspect, the third configuration message is included in an RRC message. For example, the network node may include the third configuration message in an RRC message sent to the UE. In this way, the network node ensures that the UE receives updated configuration information for accurate transmission scheduling.

In a second aspect, alone or in combination with the first aspect, the third configuration message is included in a most recently received MAC-CE message before an Scell activation. For example, the network node may provide the third configuration message in the most recently transmitted MAC-CE message before Scell activation. In this way, the network node enables the UE to validate transmission occasions using the latest configuration.

In a third aspect, alone or in combination with one or more of the first and second aspects, the valid transmission occasion is a valid PRACH occasion, and the uplink message includes a RACH message. Additionally, or alternatively, the transmission occasion is a PRACH occasion, the valid transmission occasion is a valid PRACH occasion, and the uplink message includes a RACH message. For example, the network node may identify a valid PRACH occasion and receive a RACH message from the UE during that occasion. In this way, the network node facilitates initial access and uplink synchronization for the UE.

In a fourth aspect, alone or in combination with one or more of the first through third aspects, the configuration for the candidate SSBs includes at least one of an SSB periodicity parameter, a parameter to indicate SSB positions in an SSB burst for SSB transmission, a center frequency, a subcarrier spacing, a physical cell identifier, or a quantity of SSB bursts that are to be transmitted. For example, the network node may transmit a configuration message specifying an SSB periodicity parameter, SSB positions in a burst, center frequency, subcarrier spacing, physical cell identifier, or quantity of SSB bursts to be transmitted. In this way, the network node provides the UE with parameters for synchronization and transmission scheduling.

In a fifth aspect, alone or in combination with one or more of the first through fourth aspects, process 600 includes transmitting another configuration message conveying a configuration of SSBs that are periodically transmitted. Additionally, or alternatively, process 600 includes transmitting a fourth configuration message conveying a configuration of SSBs that are periodically transmitted. In some aspects, the valid transmission occasion is mapped to another SSB transmission of the SSBs based at least in part on SSB indices corresponding to a set of SSB positions in the other configuration message. For example, the network node may transmit a configuration message that includes an SSB periodicity parameter, SSB positions in a burst, center frequency, subcarrier spacing, physical cell identifier, or quantity of SSB bursts to be transmitted. In this way, the network node enables the UE to synchronize and schedule transmissions according to the configured cell parameters.

In a sixth aspect, alone or in combination with one or more of the first through fifth aspects, the validity of the transmission occasion is based on SSB transmission according to the one or more configuration messages and SSB transmission according to the other configuration messages. Additionally, or alternatively, the validity of the transmission occasion is based on SSB transmission according to the third configuration message and SSB transmission according to the fourth configuration message. For example, the network node may determine the validity of a transmission occasion based on SSB transmissions indicated in multiple configuration messages, such as the third and fourth configuration messages. In this way, the network node ensures that uplink transmissions from the UE are aligned with the current SSB configuration.

In a seventh aspect, alone or in combination with one or more of the first through sixth aspects, the valid transmission occasion is associated with a collision rule, wherein the collision rule relates to at least one of whether the valid transmission occasion is within a threshold gap of the one or more SSBs transmitted according to the one or more configuration messages. Additionally, or alternatively, the valid transmission occasion is associated with a collision rule, wherein the collision rule relates to whether the valid transmission occasion is within a threshold gap between two adjacent SSBs of the one or more SSBs transmitted according to the third configuration message. For example, the network node may associate a valid transmission occasion with a collision rule that considers whether the occasion is within a threshold gap of one or more transmitted SSBs, as specified in the configuration messages. In this way, the network node helps prevent interference between uplink transmissions and SSB reception.

In an eighth aspect, alone or in combination with one or more of the first through seventh aspects, the third configuration message is received MAC-CE or DCI signaling. For example, the network node may transmit the third configuration message to the UE using MAC-CE or DCI signaling. In this way, the network node provides timely updates for dynamic configuration of transmission occasions.

In a ninth aspect, alone or in combination with one or more of the first through eighth aspects, a preamble repetition transmission, for the uplink message, not occurring in the valid transmission occasion is included in a configured quantity of preamble repetitions. For example, the network node may include a preamble repetition transmission, even if the preamble repetition transmission does not occur in a valid transmission occasion, in the configured quantity of preamble repetitions. In this way, the network node ensures that the total number of repetitions accounts for all scheduled transmissions.

In a tenth aspect, alone or in combination with one or more of the first through ninth aspects, a preamble repetition transmission, for the uplink message, not occurring in the valid transmission occasion is not included in a configured quantity of preamble repetitions. For example, the network node may exclude any preamble repetition transmission that does not occur in a valid transmission occasion from the configured quantity of preamble repetitions. In this way, the network node ensures that only repetitions transmitted during valid occasions are counted.

In an eleventh aspect, alone or in combination with one or more of the first through tenth aspects, the valid transmission occasion is a valid PUSCH occasion, and the uplink message is a PUSCH message. Additionally, or alternatively, the transmission occasion is a PUSCH occasion, the valid transmission occasion is a valid PUSCH occasion, and the uplink message is a PUSCH message. For example, the network node may identify a valid PUSCH occasion and receive a PUSCH message from the UE during that occasion. In this way, the network node supports efficient uplink data transmission and resource allocation.

In a twelfth aspect, alone or in combination with one or more of the first through eleventh aspects, whether the uplink message is transmitted in the valid transmission occasion is associated with whether a demodulation reference signal resource is mapped to a preamble of another occasion that is valid but in which the UE does not transmit in connection with an SSB transmission according to the one or more configuration messages. Additionally, or alternatively, whether the uplink message is transmitted in the valid transmission occasion is associated with whether a demodulation reference signal resource is mapped to a preamble of another occasion that is valid but in which the UE does not transmit in connection with an SSB transmission according to the third configuration message. For example, the network node may determine whether the uplink message is transmitted in a valid transmission occasion based on whether a demodulation reference signal resource is mapped to a preamble of another valid occasion where the UE did not transmit due to SSB configuration. In this way, the network node ensures proper alignment of reference signals and uplink transmissions.

In a thirteenth aspect, alone or in combination with one or more of the first through twelfth aspects, a collision rule is associated with whether a downlink communication is received, by a UE, in a slot that overlaps with the valid transmission occasion. For example, the network node may associate a collision rule with whether a downlink communication is received by the UE in a slot that overlaps with a valid transmission occasion. In this way, the network node coordinates uplink and downlink activities to minimize interference.

In a fourteenth aspect, alone or in combination with one or more of the first through thirteenth aspects, in accordance with the collision rule, a UE is to forgo reception in the slot. For example, the network node may specify, in accordance with the collision rule, that the UE is to forgo reception in a slot that overlaps with a valid transmission occasion. In this way, the network node ensures that the UE prioritizes uplink transmission and avoids downlink interference.

In a fifteenth aspect, alone or in combination with one or more of the first through fourteenth aspects, in accordance with the collision rule, a UE is optionally able to receive the downlink communication in the slot. For example, the network node may specify that, in accordance with the collision rule, the UE is optionally able to receive downlink communication in a slot overlapping with a valid transmission occasion. In this way, the network node allows flexible management of simultaneous uplink and downlink operations.

In a sixteenth aspect, alone or in combination with one or more of the first through fifteenth aspects, the valid transmission occasion is validated based at least in part on the configuration for the candidate SSBs in the one or more configuration messages. For example, the network node may validate a transmission occasion based at least in part on the configuration for candidate SSBs specified in one or more configuration messages. In this way, the network node ensures that transmission occasions are aligned with the current SSB configuration for reliable communication.

In a seventeenth aspect, alone or in combination with one or more of the first through sixteenth aspects, the transmission occasion is mapped to the transmitted SSB based at least in part on SSB indices corresponding to a set of SSB positions in the one or more configuration messages. For example, the network node may map a transmission occasion to a transmitted SSB based on SSB indices corresponding to a set of SSB positions specified in the configuration messages. In this way, the network node ensures precise alignment between transmission occasions and SSB resources for the UE.

In an eighteenth aspect, alone or in combination with one or more of the first through seventeenth aspects, the validity of the valid transmission occasion is based on SSB transmission according to the one or more configuration messages and SSB transmission according to the other configuration message. Additionally, or alternatively, the validity of the transmission occasion is based on SSB transmission according to the third configuration message only or SSB transmission according to the fourth configuration message only. For example, the network node may determine the validity of a transmission occasion based on SSB transmissions indicated in multiple configuration messages, or solely on the third or fourth configuration message. In this way, the network node ensures that transmission scheduling reflects the most current SSB configuration provided to the UE.

In a nineteenth aspect, alone or in combination with one or more of the first through eighteenth aspects, in accordance with a collision rule, a UE is to forgo transmission in the valid transmission occasion. For example, the network node may specify that, in accordance with a collision rule, the UE is to forgo transmission in a valid transmission occasion. In this way, the network node prevents interference and maintains efficient use of communication resources.

In a twentieth aspect, alone or in combination with one or more of the first through eighteenth aspects, in accordance with the collision rule, a UE is optionally able to transmit in the valid transmission occasion. For example, the network node may specify that, in accordance with the collision rule, the UE is optionally able to transmit in a valid transmission occasion. In this way, the network node allows flexible utilization of transmission resources based on current network conditions.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication. The apparatus 700 may be a UE, or a UE may include the apparatus 700. In some aspects, the apparatus 700 includes a reception component 702, a transmission component 704, or a communication manager 706, which may be in communication with one another (for example, via one or more buses or one or more other components). In some aspects, the communication manager 706 is the communication manager 150 described in connection with FIG. 1. As shown, the apparatus 700 may communicate with another apparatus 708, such as a UE or a network node (such as a CU, a DU, an RU, or a base station), using the reception component 702 and the transmission component 704. The communication manager 706 may be included in, or implemented via, a processing system (for example, the processing system 140 described in connection with FIG. 1) of the UE.

In some aspects, the apparatus 700 may be configured to perform one or more operations described herein in connection with FIGS. 4A-4B. Additionally, or alternatively, the apparatus 700 may be configured to perform one or more processes described herein, such as process 500 of FIG. 5. In some aspects, the apparatus 700 or one or more components shown in FIG. 7 may include one or more components of the UE described in connection with FIG. 1. Additionally, or alternatively, one or more components shown in FIG. 7 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 702 may receive communications, such as reference signals, control information, data communications, or a combination thereof, from the apparatus 708. The reception component 702 may provide received communications to one or more other components of the apparatus 700. In some aspects, the reception component 702 may perform signal processing on the received communications, and may provide the processed signals to the one or more other components of the apparatus 700. In some aspects, the reception component 702 may include one or more components of the UE described above in connection with FIG. 1, such as a radio, one or more RF chains, one or more transceivers, or one or more modems, each of which may in turn be coupled with one or more antennas of the UE.

The transmission component 704 may transmit communications, such as reference signals, control information, data communications, or a combination thereof, to the apparatus 708. In some aspects, one or more other components of the apparatus 700 may generate communications and may provide the generated communications to the transmission component 704 for transmission to the apparatus 708. In some aspects, the transmission component 704 may perform signal processing on the generated communications, and may transmit the processed signals to the apparatus 708. In some aspects, the transmission component 704 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 704 may be co-located with the reception component 702.

The communication manager 706 may support operations of the reception component 702 or the transmission component 704. For example, the communication manager 706 may receive information associated with configuring reception of communications by the reception component 702 or transmission of communications by the transmission component 704. Additionally, or alternatively, the communication manager 706 may generate or provide control information to the reception component 702 or the transmission component 704 to control reception or transmission of communications.

The reception component 702 may receive one or more configuration messages indicating a configuration for candidate SSBs and whether one or more SSBs, according to the configuration for candidate SSBs, are transmitted. The reception component 702 may receive a first configuration message conveying a RACH configuration for a transmission occasion. The reception component 702 may receive a second configuration message conveying a configuration for candidate SSBs. The reception component 702 may receive a third configuration message indicating whether one or more SSBs, according to the second configuration for the candidate SSBs, are transmitted. The transmission component 704 may transmit an uplink message in a valid transmission occasion that is mapped to an SSB of the one or more SSBs. The transmission component 704 may transmit an uplink message in a valid transmission occasion that is mapped to a transmitted SSB of the one or more SSBs that are transmitted, wherein a mapping and a validity of the transmission occasion are associated with the one or more SSBs that are transmitted according to the second configuration message and the third configuration messages. The reception component 702 may receive a fourth configuration message conveying a configuration of SSBs that are periodically transmitted.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

FIG. 8 is a diagram of an example apparatus 800 for wireless communication. The apparatus 800 may be a network node, or a network node may include the apparatus 800. In some aspects, the apparatus 800 includes a reception component 802, a transmission component 804, or a communication manager 806, which may be in communication with one another (for example, via one or more buses or one or more other components). In some aspects, the communication manager 806 is the communication manager 155 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 145 described in connection with FIG. 1) of the network node.

In some aspects, the apparatus 800 may be configured to perform one or more operations described herein in connection with FIGS. 4A-4B. Additionally, or alternatively, the apparatus 800 may be configured to perform one or more processes described herein, such as process 600 of FIG. 6. In some aspects, the apparatus 800 or one or more components shown in FIG. 8 may include one or more components of the network node described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the network node described above in connection with FIG. 1, such as a radio, one or more RF chains, one or more transceivers, or one or more modems, each of which may in turn be coupled with one or more antennas of the network node. In some aspects, the reception component 802 or the transmission component 804 may include or may be included in a network interface. The network interface may be configured to obtain or output signals for the apparatus 800 via one or more communications links, such as a backhaul link, a midhaul link, or a fronthaul link.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 804 may be co-located with the reception component 802.

The communication manager 806 may support operations of the reception component 802 or the transmission component 804. For example, the communication manager 806 may receive information associated with configuring reception of communications by the reception component 802 or transmission of communications by the transmission component 804. Additionally, or alternatively, the communication manager 806 may generate or provide control information to the reception component 802 or the transmission component 804 to control reception or transmission of communications.

The transmission component 804 may transmit one or more configuration messages indicating a configuration for candidate SSBs and whether one or more SSBs, according to the configuration for candidate SSBs, are transmitted. The transmission component 804 may transmit a first configuration message conveying a RACH configuration for a transmission occasion. The transmission component 804 may transmit a second configuration message conveying a configuration for candidate SSBs. The transmission component 804 may transmit a third configuration message indicating whether one or more SSBs, according to the second configuration for the candidate SSBs, are transmitted. The reception component 802 may receive an uplink message in a valid transmission occasion that is mapped to an SSB of the one or more SSBs. The reception component 802 may receive an uplink message in a valid transmission occasion that is mapped to a transmitted SSB of the one or more SSBs that are transmitted, wherein a mapping and a validity of the transmission occasion are associated with the one or more SSBs that are transmitted according to the second configuration message and the third configuration messages. The transmission component 804 may transmit a fourth configuration message conveying a configuration of SSBs that are periodically transmitted.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a user equipment (UE), comprising: receiving a first configuration message conveying a random access channel (RACH) configuration for a transmission occasion; receiving a second configuration message conveying a configuration for candidate synchronization signal / physical broadcast channel (SS/PBCH) blocks (SSBs); receiving a third configuration message indicating whether one or more SSBs, according to the second configuration for the candidate SSBs, are transmitted; and transmitting an uplink message in a valid transmission occasion that is mapped to a transmitted SSB of the one or more SSBs that are transmitted, wherein a mapping and a validity of the transmission occasion are associated with the one or more SSBs that are transmitted according to the second configuration message and the third configuration messages.

Aspect 2: The method of Aspect 1, wherein the third configuration message is included in a radio resource control message.

Aspect 3: The method of any of Aspects 1-2, wherein the third configuration message is included in a most recently received medium access control (MAC) control element (MAC-CE) message before a secondary cell (Scell) activation.

Aspect 4: The method of any of Aspects 1-3, wherein the transmission occasion is a physical random access channel (PRACH) occasion, the valid transmission occasion is a valid PRACH occasion, and the uplink message includes a RACH message.

Aspect 5: The method of any of Aspects 1-4, wherein the configuration for the candidate SSBs includes at least one of: an SSB periodicity parameter, or a parameter to indicate SSB positions in an SSB burst for SSB transmission.

Aspect 6: The method of any of Aspects 1-5, further comprising: receiving a fourth configuration message conveying a configuration of SSBs that are periodically transmitted.

Aspect 7: The method of Aspect 6 wherein the validity of the transmission occasion is based on SSB transmission according to the third configuration message only or SSB transmission according to the fourth configuration message only, or wherein the validity of the transmission occasion is based on SSB transmission according to the third configuration message and SSB transmission according to the fourth configuration message.

Aspect 8: The method of Aspect 6, the valid transmission occasion is mapped to another SSB transmission of the SSBs based at least in part on SSB indices corresponding to a set of SSB positions in the other configuration message.

Aspect 9: The method of any of Aspects 1-8, wherein the valid transmission occasion is associated with a collision rule, wherein the collision rule relates to at least one of: whether the valid transmission occasion is within a threshold gap of the one or more SSBs transmitted according to the third configuration message.

Aspect 10: The method of Aspect 9, wherein the third configuration message is received via medium access control (MAC) control element or downlink control information signaling.

Aspect 11: The method of Aspect 9, wherein, in accordance with the collision rule, the UE is to forgo transmission in the valid transmission occasion.

Aspect 12: The method of Aspect 9, wherein, in accordance with the collision rule, the UE is optionally able to transmit in the valid transmission occasion.

Aspect 13: The method of any of Aspects 1-12, wherein a preamble repetition transmission, for the uplink message, not occurring in the valid transmission occasion is included in a configured quantity of preamble repetitions.

Aspect 14: The method of any of Aspects 1-13, wherein a preamble repetition transmission, for the uplink message, not occurring in the valid transmission occasion is not included in a configured quantity of preamble repetitions.

Aspect 15: The method of any of Aspects 1-14, wherein the transmission occasion is a physical uplink shared channel (PUSCH) occasion, the valid transmission occasion is a valid PUSCH occasion, and the uplink message is a PUSCH message.

Aspect 16: The method of any of Aspects 1-15, wherein whether the uplink message is transmitted in the valid transmission occasion is associated with whether a demodulation reference signal resource is mapped to a preamble of another occasion that is valid but in which the UE does not transmit in connection with an SSB transmission according to the third configuration message.

Aspect 17: The method of any of Aspects 1-16, wherein a collision rule is associated with whether a downlink communication is received in a slot that overlaps with the valid transmission occasion.

Aspect 18: The method of Aspect 17, wherein, in accordance with the collision rule, the UE is to forgo reception in the slot.

Aspect 19: The method of Aspect 17, wherein, in accordance with the collision rule, the UE is optionally able to receive the downlink communication in the slot.

Aspect 20: A method of wireless communication performed by a network node, comprising: transmitting a first configuration message conveying a random access channel (RACH) configuration for a transmission occasion; transmitting a second configuration message conveying a configuration for candidate synchronization signal / physical broadcast channel (SS/PBCH) blocks (SSBs); transmitting a third configuration message indicating whether one or more SSBs, according to the second configuration for the candidate SSBs, are transmitted; and receiving an uplink message in a valid transmission occasion that is mapped to a transmitted SSB of the one or more SSBs that are transmitted, wherein a mapping and a validity of the transmission occasion are associated with the one or more SSBs that are transmitted according to the second configuration message and the third configuration messages.

Aspect 21: The method of Aspect 20, wherein the third configuration message is included in a radio resource control message.

Aspect 22: The method of any of Aspects 20-21, wherein the third configuration message is included in a most recently transmitted medium access control (MAC) control element (MAC-CE) message before a secondary cell (Scell) activation or a first MAC-CE received after receiving the second confirmation message.

Aspect 23: The method of any of Aspects 20-22, wherein the transmission occasion is a physical random access channel (PRACH) occasion, the valid transmission occasion is a valid PRACH occasion, and the uplink message includes a RACH message.

Aspect 24: The method of any of Aspects 20-23, wherein the configuration for the candidate SSBs includes at least one of: an SSB periodicity parameter, or a parameter to indicate SSB positions in an SSB burst for SSB transmission.

Aspect 25: The method of any of Aspects 20-24, further comprising: transmitting a fourth configuration message conveying a configuration of SSBs that are periodically transmitted.

Aspect 26: The method of Aspect 25, wherein the validity of the transmission occasion is based on SSB transmission according to the third configuration message only or SSB transmission according to the fourth configuration message only.

Aspect 27: The method of Aspect 25, wherein the validity of the transmission occasion is based on SSB transmission according to the third configuration message and SSB transmission according to the fourth configuration message.

Aspect 28: The method of any of Aspects 20-27, wherein the valid transmission occasion is associated with a collision rule, wherein the collision rule relates to at least one of: whether the valid transmission occasion is within a threshold gap of the one or more SSBs transmitted according to the third configuration message.

Aspect 29: The method of Aspect 28, wherein the third configuration message is received via medium access control (MAC) control element or downlink control information signaling.

Aspect 30: The method of any of Aspects 20-29, wherein a preamble repetition transmission, for the uplink message, not occurring in the valid transmission occasion is included in a configured quantity of preamble repetitions.

Aspect 31: The method of any of Aspects 20-30, wherein a preamble repetition transmission, for the uplink message, not occurring in the valid transmission occasion is not included in a configured quantity of preamble repetitions.

Aspect 32: The method of any of Aspects 20-31, wherein the transmission occasion is a physical uplink shared channel (PUSCH) occasion, the valid transmission occasion is a valid PUSCH occasion, and the uplink message is a PUSCH message.

Aspect 33: The method of any of Aspects 20-32, wherein whether the uplink message is transmitted in the valid transmission occasion is associated with whether a demodulation reference signal resource is mapped to a preamble of another occasion that is valid but in which the UE does not transmit in connection with an SSB transmission according to the third configuration message.

Aspect 34: The method of any of Aspects 20-33, wherein a collision rule is associated with whether a downlink communication is received in a slot that overlaps with the valid transmission occasion.

Aspect 35: A method of wireless communication performed by a user equipment (UE), comprising: receiving one or more configuration messages indicating a configuration for candidate synchronization signal / physical broadcast channel (SS/PBCH) blocks (SSBs) and whether one or more SSBs, according to the configuration for the candidate SSBs, are transmitted; and transmitting an uplink message in a valid transmission occasion that is mapped to an SSB of the one or more SSBs, wherein a mapping and a validity of the valid transmission occasion are associated with the one or more configuration messages.

Aspect 36: The method of Aspect 35, wherein the valid transmission occasion is validated based at least in part on the configuration for the candidate SSBs in the one or more configuration messages.

Aspect 37: The method of any of Aspects 35-36, wherein the transmission occasion is mapped to the transmitted SSB based at least in part on SSB indices corresponding to a set of SSB positions in the one or more configuration messages.

Aspect 38: The method of any of Aspects 35-37, wherein the valid transmission occasion is a valid physical random access channel (PRACH) occasion, and the uplink message includes a random access channel (RACH) message.

Aspect 39: The method of any of Aspects 35-38, wherein the configuration for the candidate SSBs includes at least one of: an SSB periodicity parameter, or a parameter to indicate SSB positions in an SSB burst for SSB transmission.

Aspect 40: The method of any of Aspects 35-39, further comprising: receiving another configuration message conveying a configuration of SSBs that are periodically transmitted.

Aspect 41: The method of Aspect 40, wherein the validity of the valid transmission occasion is based on SSB transmission according to the one or more configuration messages only or SSB transmission according to the other configuration message only.

Aspect 42: The method of Aspect 40, wherein the validity of the valid transmission occasion is based on SSB transmission according to the one or more configuration messages and SSB transmission according to the other configuration message.

Aspect 43: The method of any of Aspects 35-42, wherein the valid transmission occasion is associated with a collision rule, wherein the collision rule relates to at least one of: whether the valid transmission occasion is within a threshold gap between two adjacent SSBs of the one or more SSBs transmitted according to the one or more configuration messages.

Aspect 44: The method of Aspect 43, wherein, in accordance with the collision rule, the UE is to forgo transmission in the valid transmission occasion.

Aspect 45: The method of Aspect 43, wherein, in accordance with the collision rule, the UE is optionally able to transmit in the valid transmission occasion.

Aspect 46: The method of any of Aspects 35-45, wherein a preamble repetition transmission, for the uplink message, not occurring in the valid transmission occasion is included in a configured quantity of preamble repetitions.

Aspect 47: The method of any of Aspects 35-46, wherein a preamble repetition transmission, for the uplink message, not occurring in the valid transmission occasion is not included in a configured quantity of preamble repetitions.

Aspect 48: The method of any of Aspects 35-47, wherein the valid transmission occasion is a valid physical uplink shared channel (PUSCH) occasion, and the uplink message is a PUSCH message.

Aspect 49: The method of any of Aspects 35-48, wherein whether the uplink message is transmitted in the valid transmission occasion is associated with whether a demodulation reference signal resource is mapped to a preamble of another occasion that is valid but in which the UE does not transmit in connection with an SSB transmission according to the one or more configuration messages.

Aspect 50: The method of any of Aspects 35-49, wherein a collision rule is associated with whether a downlink communication is received in a slot that overlaps with the valid transmission occasion.

Aspect 51: The method of Aspect 50, wherein, in accordance with the collision rule, the UE is to forgo reception in the slot.

Aspect 52: The method of Aspect 50, wherein, in accordance with the collision rule, the UE is optionally able to receive the downlink communication in the slot.

Aspect 53: A method of wireless communication performed by a network node, comprising: transmitting one or more configuration messages indicating a configuration for candidate synchronization signal / physical broadcast channel (SS/PBCH) blocks (SSBs) and whether one or more SSBs, according to the configuration for the candidate SSBs, are transmitted; and receiving an uplink message in a valid transmission occasion that is mapped to an SSB of the one or more SSBs, wherein a mapping and a validity of the valid transmission occasion are associated with the one or more configuration messages.

Aspect 54: The method of Aspect 53, wherein the valid transmission occasion is validated based at least in part on the configuration for the candidate SSBs in the one or more configuration messages.

Aspect 55: The method of any of Aspects 53-54, wherein the transmission occasion is mapped to the transmitted SSB based at least in part on SSB indices corresponding to a set of SSB positions in the one or more configuration messages.

Aspect 56: The method of any of Aspects 53-55, wherein the valid transmission occasion is a valid physical random access channel (PRACH) occasion, and the uplink message includes a random access channel (RACH) message.

Aspect 57: The method of any of Aspects 53-56, wherein the configuration for the candidate SSBs includes at least one of: an SSB periodicity parameter, or a parameter to indicate SSB positions in an SSB burst for SSB transmission.

Aspect 58: The method of any of Aspects 53-57, further comprising: transmitting another configuration message conveying a configuration of SSBs that are periodically transmitted.

Aspect 59: The method of Aspect 58, wherein the validity of the valid transmission occasion is based on SSB transmission according to the one or more configuration messages only or SSB transmission according to the other configuration message only.

Aspect 60: The method of Aspect 58, wherein the validity of the valid transmission occasion is based on SSB transmission according to the one or more configuration messages and SSB transmission according to the other configuration message.

Aspect 61: The method of any of Aspects 53-60, wherein the valid transmission occasion is associated with a collision rule, wherein the collision rule relates to at least one of: whether the valid transmission occasion is within a threshold gap between two adjacent SSBs of the one or more SSBs transmitted according to the one or more configuration messages.

Aspect 62: The method of Aspect 61, wherein, in accordance with the collision rule, the UE is to forgo transmission in the valid transmission occasion.

Aspect 63: The method of Aspect 61, wherein, in accordance with the collision rule, the UE is optionally able to transmit in the valid transmission occasion.

Aspect 64: The method of any of Aspects 53-63, wherein a preamble repetition transmission, for the uplink message, not occurring in the valid transmission occasion is included in a configured quantity of preamble repetitions.

Aspect 65: The method of any of Aspects 53-64, wherein a preamble repetition transmission, for the uplink message, not occurring in the valid transmission occasion is not included in a configured quantity of preamble repetitions.

Aspect 66: The method of any of Aspects 53-65, wherein the valid transmission occasion is a valid physical uplink shared channel (PUSCH) occasion, and the uplink message is a PUSCH message.

Aspect 67: The method of any of Aspects 53-66, wherein whether the uplink message is transmitted in the valid transmission occasion is associated with whether a demodulation reference signal resource is mapped to a preamble of another occasion that is valid but in which the UE does not transmit in connection with an SSB transmission according to the one or more configuration messages.

Aspect 68: The method of any of Aspects 53-67, wherein a collision rule is associated with whether a downlink communication is received in a slot that overlaps with the valid transmission occasion.

Aspect 69: The method of Aspect 68, wherein, in accordance with the collision rule, the UE is to forgo reception in the slot.

Aspect 70: The method of Aspect 68, wherein, in accordance with the collision rule, the UE is optionally able to receive the downlink communication in the slot.

Aspect 71: An apparatus for wireless communication at a device, the apparatus comprising one or more processors; one or more memories coupled with the one or

more processors; and instructions stored in the one or more memories and executable by the one or more processors to cause the apparatus to perform the method of one or more of Aspects 1-70.

Aspect 72: An apparatus for wireless communication at a device, the apparatus comprising one or more memories and one or more processors coupled to the one or more memories, the one or more processors configured to cause the device to perform the method of one or more of Aspects 1-70.

Aspect 73: An apparatus for wireless communication, the apparatus comprising at least one means for performing the method of one or more of Aspects 1-70.

Aspect 74: A non-transitory computer-readable medium storing code for wireless communication, the code comprising instructions executable by one or more processors to perform the method of one or more of Aspects 1-70.

Aspect 75: A non-transitory computer-readable medium storing a set of instructions for wireless communication, the set of instructions comprising one or more instructions that, when executed by one or more processors of a device, cause the device to perform the method of one or more of Aspects 1-70.

Aspect 76: A device for wireless communication, the device comprising a processing system that includes one or more processors and one or more memories coupled with the one or more processors, the processing system configured to cause the device to perform the method of one or more of Aspects 1-70.

Aspect 77: An apparatus for wireless communication at a device, the apparatus comprising one or more memories and one or more processors coupled to the one or more memories, the one or more processors individually or collectively configured to cause the device to perform the method of one or more of Aspects 1-70.

Aspect 78: A device comprising a processing system that includes one or more processors and one or more code-storing memories coupled with the one or more processors, the processing system configured to cause the device to perform the method of one or more of Aspects 1-70.

Aspect 79: A device comprising a processing system that includes processor circuitry and code-storing memory circuitry, the processing system configured to cause the device to perform the method of one or more of Aspects 1-70.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is

intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
receive one or more configuration messages indicating a configuration for candidate synchronization signal / physical broadcast channel (SS/PBCH) blocks (SSBs) and whether one or more SSBs, according to the configuration for the candidate SSBs, are transmitted; and
transmit an uplink message in a valid transmission occasion that is mapped to an SSB of the one or more SSBs,
wherein a mapping and a validity of the valid transmission occasion are associated with the one or more configuration messages.

2. The UE of claim 1, wherein the valid transmission occasion is validated based at least in part on the configuration for the candidate SSBs in the one or more configuration messages.

3. The UE of claim 1, wherein the transmission occasion is mapped to the transmitted SSB based at least in part on SSB indices corresponding to a set of SSB positions in the one or more configuration messages.

4. The UE of claim 1, wherein the valid transmission occasion is a valid physical random access channel (PRACH) occasion, and the uplink message includes a random access channel (RACH) message.

5. The UE of claim 1, wherein the configuration for the candidate SSBs includes at least one of:
an SSB periodicity parameter, or
a parameter to indicate SSB positions in an SSB burst for SSB transmission.

6. The UE of claim 1, wherein the processing system is configured to cause the UE to:
receive another configuration message conveying a configuration of SSBs that are periodically transmitted.

7. The UE of claim 6, wherein the validity of the valid transmission occasion is based on SSB transmission according to the one or more configuration messages only or SSB transmission according to the other configuration message only.

8. The UE of claim 6, wherein the validity of the valid transmission occasion is based on SSB transmission according to the one or more configuration messages and SSB transmission according to the other configuration message.

9. The UE of claim 6, wherein the valid transmission occasion is mapped to another SSB transmission of the SSBs based at least in part on SSB indices corresponding to a set of SSB positions in the other configuration message.

10. The UE of claim 1, wherein the valid transmission occasion is associated with a collision rule, wherein the collision rule relates to at least one of:
whether the valid transmission occasion is within a threshold gap between two adjacent SSBs of the one or more SSBs transmitted according to the one or more configuration messages.

11. The UE of claim 10, wherein, in accordance with the collision rule, the UE is to forgo transmission of the uplink message in the valid transmission occasion.

12. The UE of claim 10, wherein, in accordance with the collision rule, the UE is optionally able to transmit the uplink message in the valid transmission occasion.

13. The UE of claim 1, wherein a preamble repetition transmission, for the uplink message, not occurring in the valid transmission occasion, is included in a configured quantity of preamble repetitions.

14. The UE of claim 1, wherein a preamble repetition transmission, for the uplink message, not occurring in the valid transmission occasion, is not included in a configured quantity of preamble repetitions.

15. The UE of claim 1, wherein the valid transmission occasion is a valid physical uplink shared channel (PUSCH) occasion, and the uplink message is a PUSCH message.

16. The UE of claim 1, wherein whether the uplink message is transmitted in the valid transmission occasion is associated with whether a demodulation reference signal resource is mapped to a preamble of another occasion that is valid but in which the UE does not transmit in connection with an SSB transmission according to the one or more configuration messages.

17. The UE of claim 1, wherein a collision rule is associated with whether a downlink communication is received in a slot that overlaps with the valid transmission occasion.

18. The UE of claim 17, wherein, in accordance with the collision rule, the UE is to forgo reception in the slot.

19. A network node, comprising:
a processing system that includes one or more processors and one or more code-storing memories coupled with the one or more processors, the processing system configured to cause the network node to:
transmit one or more configuration messages indicating a configuration for candidate synchronization signal / physical broadcast channel (SS/PBCH) blocks (SSBs) and whether one or more SSBs, according to the configuration for the candidate SSBs, are transmitted; and
receive an uplink message in a valid transmission occasion that is mapped to an SSB of the one or more SSBs,
wherein a mapping and a validity of the valid transmission occasion are associated with the one or more configuration messages.

20. A method of wireless communication performed by a user equipment (UE), comprising:
receiving one or more configuration messages indicating a configuration for candidate synchronization signal / physical broadcast channel (SS/PBCH) blocks (SSBs) and whether one or more SSBs, according to the configuration for the candidate SSBs, are transmitted; and
transmitting an uplink message in a valid transmission occasion that is mapped to an SSB of the one or more SSBs,
wherein a mapping and a validity of the valid transmission occasion are associated with the one or more configuration messages.
